(19) United States
(12) Patent Application Publication
(10) Pub. No.: US 2019/0305959 A1
(43) Pub. Date: Oct. 3, 2019

(54) ANNOUNCEMENT SMART CONTRACTS TO ANNOUNCE SOFTWARE RELEASE

(71) Applicant: CA, Inc., Islandia, NY (US)

(72) Inventors: Ashok Reddy, Islandia, NY (US); Sreenivasan Rajagopal, Islandia, NY (US); Petr Vlasek, Prague (CZ)

(21) Appl. No.: 15/943,217

(22) Filed: Apr. 2, 2018

(51) Int. Cl. H04L 9/32; G06F 21/64; G06F 8/60; G06F 8/73; H04L 29/08; H04L 9/00

(52) U.S. Cl. CPC H04L 9/3247; G06F 21/645; H04L 9/006; G06F 8/73; H04L 67/104; G06F 8/60

(57) ABSTRACT

Provided is a process that includes: calling a program executed on a decentralized computing platform configured to persist state to a blockchain, the call requesting the program to release the software asset to the production environment, wherein: respective instances of the program are configured to publish release documentation by which provenance of the software asset is verifiable to the blockchain, respective instances of the program are configured to verify a cryptographic signature associated with the software asset, the cryptographic signature establishes that the software asset being released has not been tampered with subsequent to signing, the cryptographic signature establishes that the releasing entity or a proxy of the releasing entity has access to a cryptographic key by which the cryptographic signature was formed, and the decentralized computing platform is configured to reach a consensus verification determination among verification results from the replicated instances of the program.

### CROSS-REFERENCE TO RELATED APPLICATIONS

The present patent filing is among a set of patent filings sharing a disclosure, filed on the same day by the same applicant. The set of patent filings is as follows, and each of the patent filings in the set other than this one is hereby incorporated by reference: DECENTRALIZED, IMMUTABLE, TAMPER-EVIDENT, DIRECTED ACYCLIC GRAPHS DOCUMENTING SOFTWARE SUPPLY-CHAINS WITH CRYPTOGRAPHICALLY SIGNED RECORDS OF SOFTWARE-DEVELOPMENT LIFE CYCLE STATE AND CRYPTOGRAPHIC DIGESTS OF EXECUTABLE CODE (attorney docket no. 043979-0458265); PROMOTION SMART CONTRACTS FOR SOFTWARE DEVELOPMENT PROCESSES (attorney docket no. 043979-0458266); ANNOUNCEMENT SMART CONTRACTS TO ANNOUNCE SOFTWARE RELEASE (attorney docket no. 043979-0458267); AUDITING SMART CONTRACTS CONFIGURED TO MANAGE AND DOCUMENT SOFTWARE AUDITS (attorney docket no. 043979-0458268); ALERT SMART CONTRACTS CONFIGURED TO MANAGE AND RESPOND TO ALERTS RELATED TO CODE (attorney docket no. 043979-0458269); and EXECUTION SMART CONTRACTS CONFIGURED TO ESTABLISH TRUSTWORTHINESS OF CODE BEFORE EXECUTION (attorney docket no. 043979-0458270).

### BACKGROUND

### 1. Field

The present disclosure relates generally to managing software assets and, more specifically, to announcement smart contracts to announce software release.

### 2. Description of the Related Art

Modern software is remarkably complex. Typically, a given application includes or calls code written by many different developers, in many cases who have never met one another, and often from different organizations. These different contributions can change over time with different versions, and contributors to those different versions can change over time. And information pertaining to software can be similarly complex, ranging from different regulatory requirements, audit requirements, security policies, and other criteria by which software is analyzed, along with versioning and variation in software documentation. Tooling used in the software development lifecycle imparts even greater complexity, as a given body of source code may be compiled or interpreted to various target computing environments with a variety of compilers or interpreters; and a variety of different tests (automated and otherwise) may be applied at different stages with different versions of test software for a given test. These and other factors interact to create a level of complexity that scales combinatorically in some cases.

Establishing whether software is trustworthy in such complex environments presents challenges. Attempts to partially address the challenges include various “walled gardens” offered by centrally controlled entities that vet software for use on various platforms. But in many cases, these architectures confer inordinate power on a single entity, deterring other entities from participating in the ecosystem, thereby constraining the diversity of participants in the ecosystem. Further, in many cases, these approaches still leave and users exposed to software that, with better, more reliable information, the end-user would manage differently, as a central authority often cannot adequately account for the diversity of concerns and requirements present in a wide userbase regarding trust in software assets.

### SUMMARY

The following is a non-exhaustive listing of some aspects of the present techniques. These and other aspects are described in the following disclosure.

Some aspects include a process, including: obtaining, with one or more processors, a software asset to be released by a releasing entity from a staging environment to a production environment; calling, with one or more processors, a program with replicated instances executed on a decentralized computing platform configured to persist state to a tamper-evident, immutable, decentralized data store, the call requesting the program to release the software asset to the production environment, wherein: respective instances of the program are configured to publish release documentation by which provenance of the software asset is verifiable to the tamper-evident, immutable, decentralized data store, respective instances of the program are configured to verify a cryptographic signature associated with the software asset, the cryptographic signature establishes that the software asset being released has not been tampered with subsequent to signing, the cryptographic signature establishes that the releasing entity or a proxy of the releasing entity has access to a cryptographic key by which the cryptographic signature was formed, and the decentralized computing platform is configured to reach a consensus verification determination among verification results from the replicated instances of the program; and receiving, with one or more processors, a response from the decentralized computing platform indicating that the software asset has been released to the production environment.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a schematic block diagram depicting an example of a software asset, its constituency graph across versions, and aspects of an environment in which the software asset is built and deployed, in accordance with some embodiments of the present techniques;

FIG. 2 is a flowchart depicting an example of a software lifecycle, in accordance with some embodiments of the present techniques;

FIG. 3 is a logical architecture block diagram depicting an example of a computing environment in which a decentralized computing platform and tamper-evident, immutable, decentralized data store cooperate to manage various aspects of the software lifecycle of software assets, in accordance with some embodiments of the present techniques;

FIG. 4 depicts an example of trust records of a software asset and various constituent software assets, in accordance with some embodiments of the present techniques;

FIGS. 5-11 depict evolution of trust records for a software asset through development and release of the software asset, in accordance with some embodiments of the present techniques;

FIG. 12 depicts various examples of trust-record graphs stored on a tamper-evident, immutable, decentralized data store, in accordance with some embodiments of the present techniques;

FIG. 13 is a flowchart depicting an example of a process by which trustworthiness of a software asset is determined with a smart contract, in accordance with some embodiments of the present techniques;

FIG. 14 is a flowchart depicting an example of a process by which a software asset is promoted through pre-release stages of a software development lifecycle with a smart contract, in accordance with some embodiments of the present techniques;

FIG. 15 is a flowchart depicting an example of a process by which a software release is announced with a smart contract, in accordance with some embodiments of the present techniques;

FIG. 16 is a flowchart depicting an example of a process by which audit compliance of a software asset is managed with a smart contract, in accordance with some embodiments of the present techniques;

FIG. 17 is a flowchart depicting a process by which alerts are managed for a software asset with a smart contract, in accordance with some embodiments of the present techniques;

FIG. 18 is a flowchart depicting a process by which execution, or various other invocations of functionality of a software asset, is conditioned on establishing trustworthiness of the software asset with a smart contract, in accordance with some embodiments of the present techniques; and

FIG. 19 is a block diagram depicting an example of a computer system upon which the above-describe techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of software development and devops tooling. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Software can be characterized as an asset and, in many cases, as constituted by other software assets. Examples of software assets include an application (e.g., a native app) to book a flight, an application that facilitates programmatic interaction to access online accounts, an email application, and the like. Software assets can take many forms, including software assets implementing client-server models (with examples existing both on the server and client side) or in peer-to-peer applications. Software assets can be constructed as monolithic applications, with (or as) micro-services, or as lambda functions in serverless architectures, among other design patterns. Software assets can be deployed at various levels of a software stack, ranging from the application layer, to operating systems, and down to drivers, firmware, and microcode.

Software assets can be composed of multiple other related constituent software assets, some of which may be shared across multiple software assets of which they are a part. And those constituent software assets may themselves be composed of multiple software assets. For instance, a given software asset may include constituent software assets such as 10 source files written in Java™ or some other language (e.g., in source code, byte code, or machine code formats) specifying business logic, presentation logic, data logic, and other algorithms that are compiled (or interpreted) and built into an executable software asset. In other examples, the constituent software assets are not compiled into a single executable but are accessed via system calls or network interfaces, e.g., in different hosts via application program interface requests and responses.

Often, the provenance of software assets is uncertain. Lack of trustworthy software often leads to breaches that can cause heavy reputational and monetary damage to businesses and exposure to cyber threats. In some cases, software assets are hosted by third parties, in repositories with unknown security protection measures, or are under the control of third party developers. Further, even when a software asset is reliably developed and hosted, the software asset may still be exposed to tampering during transit across a network and when deployed. Examples of areas of concern include the following:
a) Is the software asset coming from trusted vendor?
b) Are APIs accessed by software assets (which may themselves be exposed by software assets) secure?
c) Does the application and dependent components use the latest security modules?
d) Has the software asset passed a set of expected test scenarios proving its quality, security, and compliance?
e) Was the software asset built by trusted build tools?
f) Is the provided documentation of a software asset authentic?
g) Is the software asset compliant with standards and regulations (e.g., Federal Information Processing Standards (FIPS), Health Insurance Portability and Accountability Act (HIPAA), Safety Act, and the like)?
h) Is there an auditable and reliable trail documenting a provenance of modules from which the software asset was built and what dependencies it is using?
i) Is there an auditable and reliable trail documenting the entire software delivery lifecycle to audit, recreate, identify, and resolve issues?

Thus, there is a need for reliable identification and verification of quality-related step in the lifecycle of software, along with verification of ownership and sourcing of software assets (and particularly constituent software assets) involved in a software development lifecycle and delivery supply chain. Such verification may include providing the ability to trace, audit and comply with rules and regulations increases trustworthiness of software. (It should be emphasized that not all embodiments necessarily address all of the above-described issues, as various techniques described herein may be deployed to address various subsets thereof, which is not to suggest that other descriptions are limiting.)

To mitigate the above-described issues and other issues described below (and that will be apparent to a reader of ordinary skill in the art), some embodiments help a digital business establish digital trust and provenance using blockchain technology for their software assets, including their digital supply chain related to those assets, to drive innovation with speed at a lower digital risk relative to some traditional approaches. Some embodiments record information about a software supply-chain in a blockchain (or other directed acyclic graph of cryptographic hash pointers). Units of documented code (such as constituent software assets) may include dependencies (including third-party API's, frameworks, libraries, and modules of an application), each of which may recursively include its own constituent software assets. The blockchain may include or verifiably document for each such constituent of the application relatively fine-grained information about versions, and state of those versions in a software-development life-cycle (SDLC) workflow. Some embodiments may further include for each version or record of state in the SDLC a cryptographically signed hash digest of the version or record of state (or the version/record itself), signed using public key infrastructure (PKI) by a participant of the system. To facilitate relatively low-latency reads, some embodiments may execute the blockchain's consensus algorithm on a permissioned network, substituting proof of stake or proof of authorization for proof of work. To facilitate broad adoption, some embodiments may integrate permissioned and permission-less implementations.

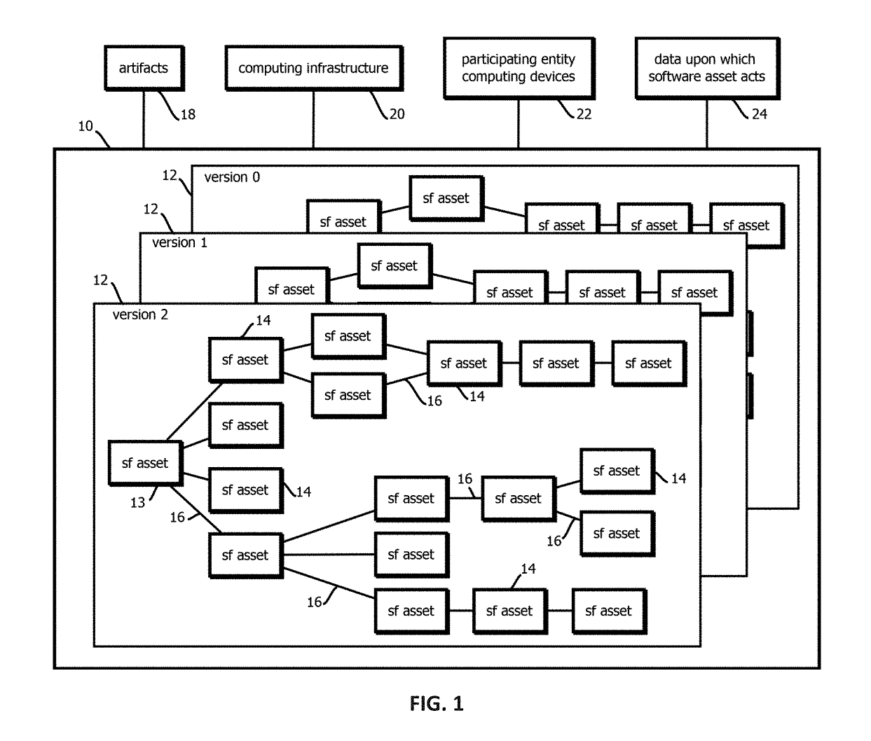

FIG. 1 is a block diagram depicting a model of a data model of, and related entities affecting, a software asset. A given software application 10 (or other form of software) may evolve over time in the form of different versions 12. In some cases, these versions may be serial, consecutive versions, or in some cases, different versions may exist in parallel form, for example, as different branches of a version graph, which in some cases may be merged back into a mainline branch of the graph.

As illustrated, each of the versions 12 may include a software asset 13 that provides an entry point to a constituency graph of the version 12. In some use cases, aspects of trustworthiness of other software assets 14 in the constituency graph of software asset 13 may be attributable to the software asset 13. For example, if the software asset 13 calls a library with a known vulnerability, then the software asset 13 may itself be deemed trustworthy. Various other examples are described below. The constituency graph may include a plurality of constituent software assets 14 having functionality invoked, either directly or indirectly by the software asset 13.

In some embodiments, the constituency graph may include a plurality of edges 16 corresponding to relationships between software assets by which functionality is invoked. In some embodiments, those relationships may indicate a manner and causal direction in which functionality is invoked. For example, one type of edge 16 may indicate that a given software asset is a library that is called by another software asset. In some embodiments, the edges may be directional indicating a direction of the call. In some embodiments, each edge 16 may connect two and only two software assets. In some embodiments, some of the edges indicate that one software asset is a framework that calls another software asset connected by that edge. In some embodiments, the edges correspond to application program interface calls from one software asset to another software asset or results of registered callbacks. In some embodiments, the edges 16 indicate that one software asset is a submodule of another software asset, such as a subroutine, method, object in an object-oriented programming environment, function, or the like. In some cases, a sub-graph or all of the constituency graph may be characterized as a call graph of a software asset.

In some cases, the edges 16 may be expressed as function calls, method calls, system calls, registered callbacks, application program interface calls, entries in a manifest, include statements, entries in a header, or various other expressions by which one body of code invokes another. In some cases, software assets may be encoded any programming language, by code, or machine code with reserve terms that signal such an invocation and identify the invoked body of code according to a grammar and syntax of the language, and some embodiments may be configured to parse program code to extract records defining the edges 16 and identifying software assets 14.

The illustrated software assets may be units of software subject to the same or similar processes (that are within the ambit of a trustworthiness determination) during a software lifecycle. For example, a software asset may be a body of code developed by one or more developers in a given organization and compiled or interpreted as a unit or separately, depending upon whether the software asset is constituted by other software assets. Examples include executables of monolithic applications, operating systems, container engines, virtual machines, applications by which services are provided in a service-oriented architecture, lambda functions in serverless architectures, scripts, submodules of programs, frameworks, libraries, application program interfaces, native applications, drivers, firmware, microcode, and the like. Software assets may be encoded as source code, byte-code, machine code, or various other formats by which executable instructions are expressed. In some cases, one software asset may be transformed into another, e.g., when compiled to a target platform, which may correspond to an edge in the constituency graph indicating that functionality is invoked by identity in a particular language of byte or machine code of a target platform.

In some cases, the constituent software assets 14 of software asset 13 have a hierarchical tree structure or other form of graph. For example, software asset 13 may invoke functionality of four constituent software assets, and some of those software assets may in turn invoke functionality of other software assets, as illustrated in the example of FIG. 1. Constituency graphs may take a variety of different forms, and in some cases may be acyclic graphs (or some embodiments may be configured to detect and handle cycles in the constituency graph as described below). The illustrated constituency graph is expected to be relatively simple compared to constituency graphs of many commercial applications, which in some cases may include more than 10, more than 100, or more than 1000 constituent software assets.

In some embodiments, only one of the software assets of a constituency graph may change between versions, such as software asset 13 that serves as an entry point, or in some cases any subset of the software assets may change between versions 12. In some embodiments, a given software asset may have an identifier that is persistent across the versions (such as a name of software application 10 or other program) and a version identifier that collectively uniquely identify the software asset, among other unique identifiers such as hash digests of code of the software asset.

In some embodiments, some of the software assets may be remotely hosted software assets, such as software assets that expose an application program interface called by another software asset. In some embodiments, software assets may execute in different processes from one another, such as software assets that are invoked via a system call or a loopback Internet protocol address. In some cases, software assets the invoke one another may execute in different levels (e.g., of privilege or abstraction) of an operating system, e.g., with a kernel serving as a software asset, various drivers being software assets, a virtual machine being a software asset, and an application executing in the virtual machine being another software asset.

In some embodiments, the ecosystem may include artifacts 18, which may include various records corresponding to specific software assets, such as documentation of program code, user manuals, installation manuals, release notes, readme files, and the like. The ecosystem may further include computing infrastructure 20 upon which a given version of the software executes, which may include a variety of different architectures including peer-to peer computing networks, monolithic applications on a single computing device, client-server architectures, and the like, which may be deployed in data centers, desktop computers, mobile computing devices, embedded systems, and the like. In some cases, for instance, the computing infrastructure 20 may include a data center in which a software as a service web application is hosted and a user computing device by which a client application, like a web browser or native application, accesses resources hosted by the data center via the web application or other interface.

The ecosystem may further include computing devices of participating entities 22, which in some cases may include various computing devices by which the software is composed, audited, tested, monitored, commented upon, probed for vulnerabilities, and the like.

In some cases, the ecosystem further includes data upon which the software assets act, as indicated by block 24, which in some cases may include data stored in persistent storage or dynamic random-access memory across various databases and other forms of program state.

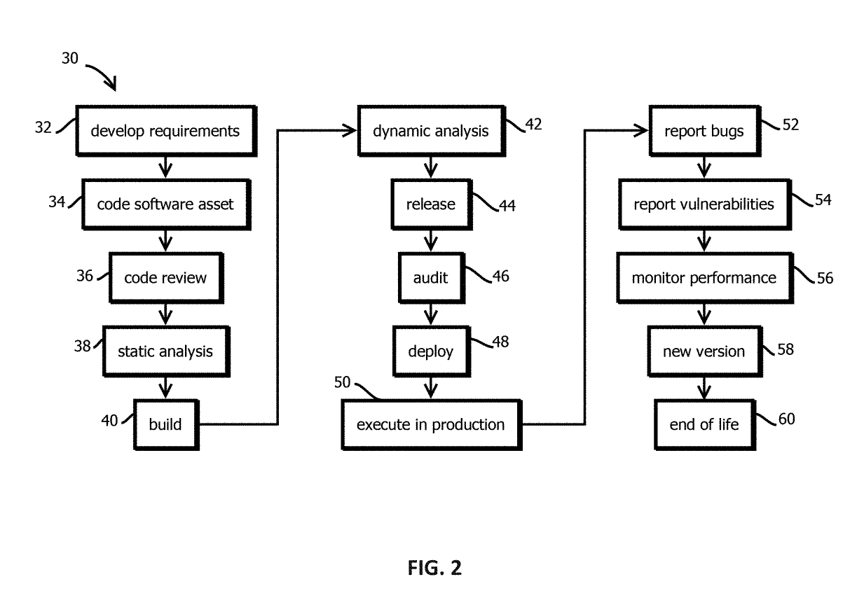

In many commercially relevant use cases, a given software asset may undergo a software lifecycle 30 like that shown in FIG. 2. In some cases, there may be additional stages, some stages may be omitted, some stages may be repeated until certain criteria are satisfied, and some stages may be executed concurrently, none of which is to suggest that any other feature described herein is not also amenable to variation consistent relative to the examples in this disclosure. In this example, the lifecycle may begin with development of requirements for the software asset, as indicated by block 32. In some embodiments, a participating entity may engage with their computing device to compose a requirements document that may serve as one of the above-described artifacts. Based on the development requirements, the same or a different participating entity may access various computing devices to develop code of the software asset, as indicated by block 34. In some cases this may include interfacing with code and tying that code to other software assets with a text editor, an independent development environment, or the like, and organizing versions of the software asset in a version control system, such as Git™, Mercurial™ or Subversion™, which may be executed by various operations by which a developer checks out a version, develops a parallel branch of the software asset, and then merges that branch back into a mainline branch, for example, after various tests are performed and passed.

In some embodiments, the pipeline may further include code review, as indicate by block 36, which may include having another developer review, comment on, enter entries in an issue tracking repository regarding, or modify candidate versions of a software asset with a different or the same developer computing device. Code review may include review for mistakes, adherence to a style policy of an organization (for instance, specifying whether tabs or spaces are to be used for indentation, a number of characters per column, a namespace, commenting practices, or whether use of global variables is permitted).

In some cases, the process 30 may further include static code analysis with a static analysis application, as indicated by block 38. In some embodiments, a program may be configured, for instance with a static analysis policy, to analyze programmatically a version of code, for instance, in source code form, of a software asset. Examples include abstract interpretation (e.g., with Frama-C or Polyspace), data-flow analysis, Hoare logic, model checking, and symbolic execution. In some embodiments, this application may output a record indicating results of the analysis, for instance, listing criteria of the static analysis that were failed, and mapping those failures to specific portions of the code that was analyzed, for instance, in a static analysis output record that identifies failures with a failure type and line number of failing code, in some cases with a path through a call-graph to the failing code.

In some cases, the preceding portions of the lifecycle may involve source code of the software asset. Some embodiments of the pipeline may include a build operation 40 by which a human readable body of source code is compiled or interpreted into machine code or byte code, respectively, or the code is otherwise packaged and formatted for execution, e.g., on a target platform (like an OS version). In some embodiments, the build operation 40 may be executed by inputting the source code into a compiler or interpreter of a specific name and version, in some cases with a set of configurations applied, and the compiler or interpreter may output a body of machine code or byte-code. In some embodiments, building may include higher level aggregations of functionality, for example, forming machine images of a virtual machine with both the software asset and an operating system and various dependencies present in a file system of the machine image, or forming a container image from which containers may be instantiated with an isolated virtualized operating system in which the software asset executes.

In some embodiments, the pipeline may include various dynamic analysis tests 42 of the as built software asset. Examples of dynamic analysis may include unit tests, performance tests, penetration testing, performance tests, fuzzing, program analysis, runtime verification, software profiling, functionality tests, stress test, and the like. Each of these tests may be executed by a respective test application having a respective version and may output a respective test result, in some cases, which may depend upon respective test configurations applied in the respective tests.

When the software asset fails to pass any of the various tests 36, 38, 42, and the like, in some cases, the software asset may be returned to other earlier stages for further refinement, and in some cases, evolution into a different software asset.

Upon passing various dynamic analysis tests, in some cases, the software asset may be released, as indicated by block 44. Release may include installing the software asset in a production environment, uploading the software asset to a software repository accessed by a package manager, adding the software asset to machine images or container images, instantiating instances of the software asset in existing containers, machine images, or creating lambda functions in serverless environments that embody the software asset. In some embodiments, release may include uploading the software asset to a software repository hosted by an entity that manages a walled garden of software assets and imposes various policies upon permitted software assets, like those described below related to trustworthiness. Examples include entities hosting repositories for native applications, like those offered by various entities that provide mobile operating systems. In some cases, the present techniques may be used by a central authority operating a walled garden environment to assess and manage trustworthiness of software assets within the walled garden. Other examples include repositories of approved executables in enterprise computing environments.

In various portions of the lifecycle 30, a software asset may be subject to auditing, as indicated by block 46. Various examples of audits are described below, and in some cases, audits may be triggered upon changes in versions of the software asset, periodic expirations of time, changes in policies or regulations, changes in use cases, or the like.

In some embodiments, the lifecycle includes deployment of the software asset, as indicated by block 48, which in some cases may include modifying compose files to reference the software asset, modifying manifests to references software asset in other software assets, adding the software asset to machine images for virtual machines, adding the software asset the container images, adding the software asset to an inventory of software assets managed by a configuration management application or orchestration tool, or the like.

After deployment, in some cases, the software asset may be executed in production, as indicated by block 50. In some cases, this may include executing the software asset in a data center, downloading the software asset to a client computing device for execution in a web browser or as a native application, executing the software asset in a peer-to-peer computing environment, installing the software asset in an embedded system, programming a field-programmable gate array to execute the software asset, and executing the software asset in non-virtualized devices and operating systems, virtual machines, containers, or as lambda functions in serverless environments.

In some cases, additional artifacts may be generated regarding the software asset during execution in production. For example, various parties may report software bugs, as indicated by block 52, report vulnerabilities, as indicated by block 54, and application performance monitoring and management software may monitor performance of the software asset, as indicated by block 56. Each of these operations 52, 54, and 56 may be performed by different entities (e.g., humans, organizations, or software applications thereof) through operation of different computing devices and corresponding applications and may generate records regarding the software asset that may be of interest to various users of the software asset or other stakeholders. These records may be cryptographically signed, published to a blockchain, and interrogated in the manner described below.

In some cases, a new version of the software asset may be announced, as indicated by block 58, and subsequently the software asset may be designated as being at its end of life or end of support, as indicated by block 60. In some cases, the software asset may continue to be used after new version is available, for example, until a new version has undergone a qualification process for a given user, which may be characterized as a type of audit and dynamic analysis in some cases done by a particular entity using the software asset.

In some cases, a given organization may interface with hundreds or thousands of software assets at various different stages of a software lifecycle like that shown in FIG. 2, and those software assets may be composed of relatively complex arrangements of constituent software assets like those described above with respect to FIG. 1. These arrangements can give rise to considerable complexity.

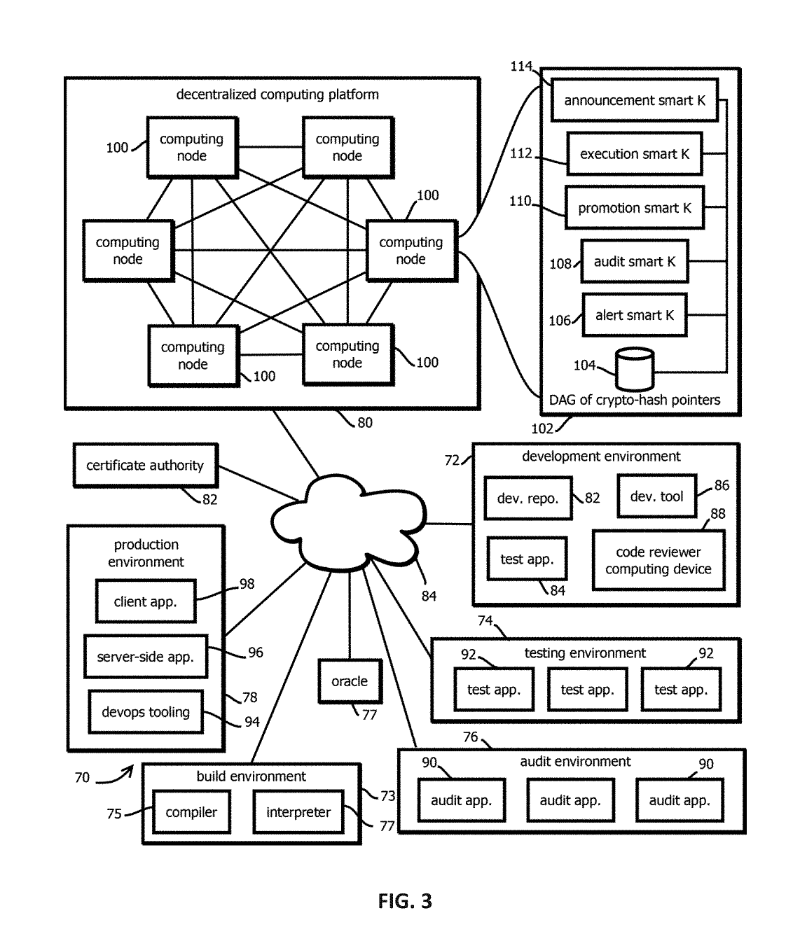

FIG. 3 is a block logical architecture diagram showing an example of a computing environment 70 that may mitigate various subsets, and in some cases all, of the above-described issues in various aspects. In some embodiments, the computing environment 70 may manage various aspects of trust related to a plurality of the above-described software assets during various stages of the above-described software lifecycle. It should be emphasized that the term “trust” does not require a particular state of mind. Rather, in this context, the term “trust” refers to a determination that various specified criteria by which trust is established have been satisfied. These criteria may be explicit in various examples of policies described below, with different entities applying different policies and trust criteria to the same software asset, in some cases reaching different results regarding the trustworthiness of that software asset. Or in some cases, the trust criteria may be implicit in various gating determinations regarding advancement or use of a software asset in the above-described software lifecycle. A policy and criteria need not be labeled as such explicitly in program code to constitute a policy or criteria, provided they afford the functionality attributable to these items here, which is not to suggest that any other term is used in a narrow sense in which the same terminology must be used in program code.

In some cases, each of the functional blocks of the illustrated logical architecture may be implemented in a different software module, application, in some cases process or computing device, for instance, in different virtual machines, containers, or the like. Or any subset or all of the described functionality may be aggregated in one or more computing devices. In some cases, this functionality may be implemented with program code stored on a tangible, non-transitory, machine-readable medium, such that when that program code is executed by one or more processors, the described functionality is effectuated, as is the case with the functionality described herein with reference to each of the figures. In some cases, notwithstanding use of the singular term “medium,” the program code may be distributed, with different subsets of the program code stored in memory of different computing devices that provide different subsets of the functionality, an arrangement consistent with use of the singular term medium herein.

In some embodiments, the computing environment 70 includes components controlled by a plurality of different entities, in some cases, different organizations or individuals, and in some cases, those different entities may not coordinate with one another or trust one another. Thus, in some cases, the computing environment 70 may operate without a central authority designating records as authoritative, designating determinations of (or logic of) certain scripts as authoritative, or gating access to the described records. Or in some cases, subsets may be implemented with permissioned, trusted computing environments or hybrid permissioned trusted computing environments and untrusted permissionless computing environments.

In some embodiments, the computing environment 70 includes a development environment 72, a testing environment 74, and audit environment 76, a production environment 78, a decentralized computing platform 80, a certificate authority 82, and various networks 84, such as the Internet, in-band networks of a data center, local area networks, wireless area networks, cellular networks, and the like. In some embodiments, the computing environment 70 further includes an oracle 77.

In some embodiments, each of, or various subsets of, the various blocks of functionality depicted in computing environment 70 may have a respective public-private cryptographic key pair. In some embodiments, there may be multiple instances of individual ones of the depicted functional blocks, such as multiple developer tools 86, and each instance may have a respective unique public-private cryptographic key pair. In some embodiments, output, and in some cases requests or other commands from the various illustrated components may be cryptographically signed with the private key of these key pairs by the component producing the output. In some embodiments, the private cryptographic keys may be stored locally on a computing devices on which the various components execute, for example, in a region of an address space accessible by the respective component, and the private cryptographic keys may be kept secret from other entities, and in some cases stored in encrypted form or held within a secure element of the local computing device and accessed via interrupts by requesting a separate secure coprocessor, different from a processor executing the illustrated component, to cryptographically sign a message. In some cases, the public cryptographic keys of the various components may be accessible to the other components, for example, stored in an index that associates identifiers of various instances of components with their public cryptographic key, and messages may be sent bearing those identifiers to facilitate confirmation at a receiving computing component that the message was sent by an entity with access to a private cryptographic key corresponding to the purported sender.

Cryptographic signatures may take various forms. In some embodiments, a component may cryptographically sign a message by computing a cryptographic hash digest based on the message, for instance, by inputting both the message, an identifier of the signing entity, and a timestamp into a cryptographic hash function to output a cryptographic hash value. In some embodiments, this cryptographic hash value may then be encrypted with the private encryption key. The resulting ciphertext may then be sent with the message (including the entity identifier and timestamp) to a recipient component, e.g., via publishing the message to a blockchain or directly. The recipient component may then retrieve a public cryptographic key corresponding to the sender's identifier (e.g., via the above-described index), decrypt the ciphertext with the public key, and access the cryptographic hash value therein.

The receiving component may than recalculate the cryptographic hash digest based upon the received message, re-creating the operations performed by the sender and determine whether the re-created cryptographic hash digest matches the decrypted cryptographic hash digest extracted by decrypting the ciphertext with the public cryptographic key of the purported sender. Upon determining that the hash digests match, the receiving component may determine that the message was sent by the purported sender and that the message was unaltered between being received and being signed. In some cases, messages be may be sent by writing the messages to a public repository or other repository for later consumption by recipient, or messages may be sent directly, for example, with application program interface calls, emails, remote procedure calls, and the like.

In some embodiments, the cryptographic hash digests described herein may be calculated by inputting values to be hashed into various hash functions, examples including MD5, SHA-256, SHA-384, SHA-512, SHA-3, and the like. The cryptographic hash function may intake an input of arbitrary length and produce an output of fixed length (e.g., with the Merkle-Damgård construction). The cryptographic hash function may be deterministic and impose a relatively low computational load relative to attempts to compute a hash collision (e.g., consuming less than 1/100,000^{th} the computing resources). In some cases, a change to any part of an input may produce a change in an output of the cryptographic hash function, even if the change is as small as flipping a single bit.

In some embodiments, private and public cryptographic key pairs may be generated with various asymmetric encryption algorithms, examples including RSA, elliptic curve, lattice-based cryptography, and various post quantum asymmetric encryption algorithms. Or in some cases, encryption keys may be symmetric, and values may be encrypted by applying a relatively high entropy value, like a random value, known to both a sender and recipient (e.g., with a one-time pad or previously exchanged via an asymmetric encryption protocol) with an XOR operation to produce a ciphertext.

In some embodiments, a certificate authority 82 may serve as a proxy for the sender with respect to authenticating the sender to the recipient. For example, a sender may establish the authenticity of the sender's identity with the certificate authority, for example, by supplying a cryptographic signature based upon a previously established private-public cryptographic key registered with the certificate authority or asymmetric cryptographic key known to the certificate authority in the sender or passing an audit. The certificate authority 82 may then cryptographically sign the message on behalf of the sender, in some cases appending to the message being signed an authenticated identity of the sender, thereby signing both the identity and the message in the cryptographic signature of the certificate authority. In some cases, recipients may then perform operations like those described above to verify the signature of the certificate authority (e.g., with reference to public cryptographic key of the authority in a root certificate that is locally stored) and thereby verify both the sender as having been authenticated by the certificate authority and the message as having been unaltered since being signed. In some cases, a single certificate authority may sign messages on behalf of a plurality of different senders, thereby simplifying key exchanges. For instance, a single root certificate stored on a receiver's computing device may be accessed to determine whether to authenticate signatures that purport to authenticate a plurality of different senders by operation of the certificate authority 82.

In some illustrated examples in FIG. 3, a single instance, or relatively few instances of each of the components of the computing environment 70 are shown, but it should be emphasized that there may be many more instances, and commercial embodiments are expected to include substantially more instances of each of the illustrated components, such as more than five of each, more than 50 of each, more than 500 of each, more than 5000 of each, or more than 50,000 of each, depending upon the size of the ecosystem built around the computing environment 70. In some cases, the number of transactions executed in ecosystems of this scale may be relatively large, examples including more than one transaction per minute, one transaction per second, 10 transactions per second, or 100 transactions per second on average over a trailing duration of one week. In some cases, some transactions may be relatively latency sensitive, for instance, with maximum or average transaction request response times being less than one minute, 10 seconds, one second, 500 ms, or 100 ms. In some cases, these transactions may read or write records, for instance, trust assertions in the below-described trust records, indicative of functionality invoked by or performed by the various illustrated components, including configuration supplied by the components, identifiers of the components, reports on outputs of the components, timestamps of when functionality is invoked or a record is output, identifiers of inputs to the components, identifiers of computing devices or operating systems in which the component executes, identifiers of users invoking functionality of the components, identifiers of entities making the components, identifiers of organizations of users, and the like. In some cases, the identifiers may be cryptographic hash digests of some or all of comprehensive descriptions of the respective thing being described, like a cryptographic hash of a set of configuration settings, an executable file of a test application, a source code format file of a software asset, or the like.

In some embodiments, the development environment 72 may include the applications that operate upon software assets before those software assets are refined for purposes of testing or releasing the production, in some cases operating upon software assets encoded in source code format. In some embodiments, the development environment includes applications executed by developer computing devices and hosted services accessed by those computing devices to define source code, including a development repository 82, a test application 84, development tools 86, and code reviewer computing devices 88. In some embodiments, the development repository 82 may include a Git repository or other version control system by which a developer, by operation of their computing device, checks out a software asset, forms a branch version of the software asset, and submits a request to merge the software asset back into a mainline branch, for instance along with a record showing a set of differences between the merged version and the existing version. In some embodiments, merged or premerger software assets may be tested, for example, with static code analysis, test application 84, and in some cases, various developer tools 86, like independent development environments and text editors may manipulate the source code of the software asset. In some cases, for example upon one developer requesting to merge a software asset back into a mainline branch, another developer operating code reviewer computing device 88 may review the software asset proposed to be merged and submit records approving the merger, designating portions of the software asset as having issues that prevent merger, or otherwise providing commentary describing and approving or rejecting the merger.

In some embodiments, the computing environment 70 may include a build environment 73, which may include a compiler 75 or an interpreter 77, and which may input source code and output machine code or byte code, respectively, in some cases based upon configuration settings applied to a particular build. In some cases, builds may have a target computing system, like a target operating system, target virtual machine, target unikernel, target application-specific integrated circuit, target field programmable gate array, or the like.

Some embodiments may further include a testing environment 74 with various test applications 92. In some embodiments, these test applications may include static or dynamic test applications. Examples of each are enumerated above. In some embodiments, dynamic tests may be executed on built code. Outputs of test applications may include descriptions of the tests, tests that were applied, versions of test applications that applied the tests, identifiers of the test applications, identifiers of vendors of the test applications, types of the tests, descriptions of which tests were passed, descriptions of which tests failed, identifiers of portions of a software asset that passed or failed various tests, scores indicative of the degree to which tests were passed, and the like.

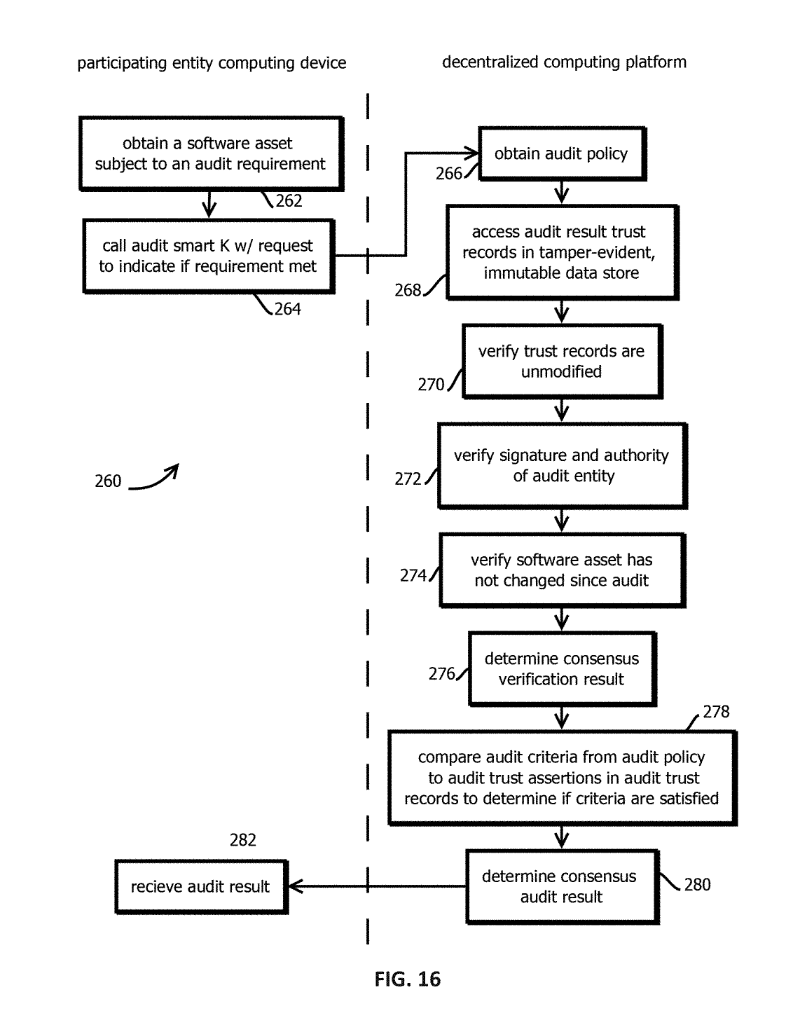

Some embodiments may further include an audit environment 76 having various audit applications 90. In some cases, the audit application 90 is an application by which a human auditor submits a result of a manual audit of a software asset, either auditing source code, artifacts, or built versions of the software asset, or combinations thereof. In some embodiments, the audit applications 90 may be configured to automatically audit one or more of these inputs, for instance, by applying various audit criteria specified by an audit definition file. Examples include applications configured to detect the presence of patterns in source code or built code indicative of code subject to various licenses, like various types of open source licenses or closed source licenses. Some embodiments of the audit environment may include an audit application configured to output a report listing portions of a software asset responsive to a pattern indicative of a particular license and an associate identifier of that license. Other examples of audit applications are described below with reference to FIG. 16.

Some embodiments may include various oracles 77. Oracles may be components configured to inject state into the various smart contracts described below in authoritative records, e.g., written to a blockchain. In some cases, oracles may be designated trusted entities authorized to report on various types of facts about the outside world in cryptographically signed messages. Different oracles may have different scope of authorized reporting. For example, a given oracle may report on a state of regulatory requirements, such as an oracle operated by a government entity having a corresponding private cryptographic key by which the government entity submits changes to audit requirements. Another example of an oracle is an entity (like a computer operated by a CTO) that submits changes to enterprise security policies by which trust criteria are expressed. In some cases, the oracle 77 includes an entity detects events and injects reports of approved, vetted, security alerts. In some cases, the various components may be characterized as corresponding oracles with respect to their area of functionality, for instance audit oracles, testing oracles, code review oracles, policy oracles, and the like.

In some embodiments, the production environment 78 may include components by which a software asset is executed in its deployed form. Examples include a client application 98 that is the software asset, or is an environment in which the software asset executes (e.g., a web browser in which WebAssembly™ or JavaScript™ software assets execute). Or in some cases, the software asset may be accessed by the client application 98, for instance, via network 84. In some embodiments, the production environment further includes a server-side application 96, which may itself be the software asset, or may interface with a client-side software asset, or may interstate face with other server-side software assets executed in a data center, for instance, in a microservices architecture. Some embodiments may further include peer-to-peer applications that include software assets or interface with software assets. Embodiments may further include devops tooling 94 by which software assets are deployed and managed. Examples include orchestration tooling, elastic scaling tooling, configuration management tooling, platforms by which serverless lambda functions are deployed and executed, service discovery tooling, domain name services, and the like.

In some embodiments, some logic and state may be offloaded to a decentralized computing platform 80. Depending upon the use case, different criteria may be applied when determining which aspects of logic and state are offloaded from other components of the computing environment 70 to the decentralized computing platform 80. In some cases, logic or state for which multiple entities need to agree upon the logical rules applied or the values and records may be offloaded to the decentralized computing platform, particularly when those different parties cross organizational boundaries or lack some other lightweight protocol by which trust is established.

In some embodiments, the decentralized computing platform 80 may be a peer-to-peer computing network in which no single computing device serves as a central authority to control the operation of the other computing devices in the peer-to-peer computing network. In some embodiments, the decentralized computing platform combines a Turing complete scripting language with a blockchain implementation. In some embodiments, the decentralized computing platform is an implementation of Ethereum™, Hyperledger Fabric™, Cardano™, NEO™ or the like, or a combination thereof.

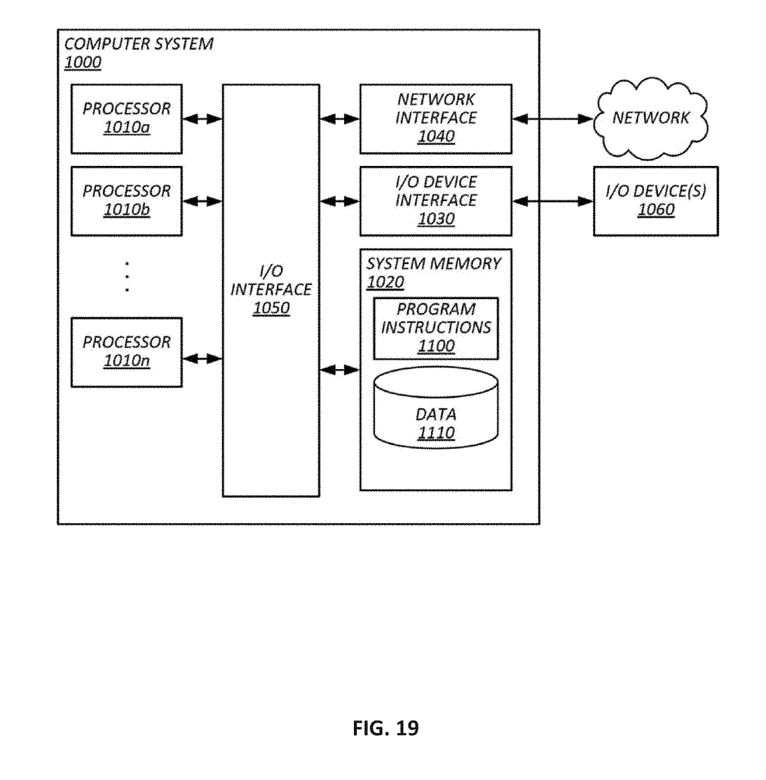

Six computing nodes 100 are shown in the decentralized computing platform, but commercial implementations are expected to include substantially more, such as more than 10, more than 100, more than 1000, or more than 10,000 computing nodes. In some embodiments, the computing nodes may all be operated within the same data center, for example, in a permission, nonpublic, trusted decentralized computing platform. Or in some cases, the computing nodes 100 may be operated on different computing devices, controlled by different entities, for example, on public, permissionless, untrusted decentralized computing platforms in which no single computing node 100 is trusted to provide correct results, accurately store data, or otherwise not be under the control of a malicious actor. In some cases, multiple computing nodes 100 may be executed on the same computing device, for example, in different virtual machines or containers or processes. In some cases, the computing nodes 100 are peer client applications that cooperate with one another to effectuate the functionality described herein is attributed to the decentralized computing platform. In some cases, the computing nodes (and other components) may be executed by computing devices like those described below with reference to FIG. 19 (as is the case with the other computing devices described herein executing the other components of the computing environment 70).

In some cases, some of the computing nodes 100 may be executed on special-purpose computing devices, like application specific integrated circuits having some or all of the functionality of the peer client application hardwired into the circuitry of the ASIC. Or a similar approach may be applied with a field programmable gate array to afford relatively high-performance computing nodes, in some cases in the absence of a host operating system. In some embodiments, the computing nodes may be executed on graphics processing units. In some cases, a subset of the functionality of the computing nodes may be executed on these types of specialized processors (e.g., on a proof of work co-processor having hardwired logic configured to calculate hash collisions), while other aspects may be executed on a general-purpose central processing unit, for instance, proof of work, proof of stake, or proof of storage algorithms may be executed on a special-purpose coprocessor. In some embodiments, the computing nodes may be geographically distributed, for example, over the United States or the world, with some computing nodes being more than 100 or 1000 km from one another, and in some cases, the computing nodes 100 may communicate with one another over the Internet.

As noted, different types of decentralized computing platforms 80 may be implemented. In some embodiments, the decentralized computing platform may be a permission decentralized computing platform in which only computing nodes under the control or otherwise authorized by a central controlling entity participate in the decentralized computing platform. In some embodiments, the decentralized computing platform may be a permissionless decentralized computing platform in which no central authority authenticates or authorizes computing nodes 100 to participate in the decentralized computing platform 80, and any member of the public can install an instance of a peer client application and participate in the decentralized computing platform 80. In some embodiments, the decentralized computing platform 80 may be a trusted decentralized computing platform, either in the permission or permissionless configuration, or in some cases, the computing nodes 100 may be trusted.

In some embodiments, the decentralized computing platform may be a hybrid decentralized computing platform that include subsets of computing nodes in subnetworks that collectively form a hybrid decentralized computing platform, with different subnetworks being permission to or permissionless or trusted or untrusted, in some cases with an oracle 77 serving as a gateway between permission and permissionless or trusted and untrusted subnetworks. In this scenario, the oracle 77 may verify operations of permissionless or untrusted decentralized computing platforms on behalf of trusted, permission decentralized computing platforms.

In some embodiments, particularly in an untrusted or permissionless decentralized computing platforms, logic executed by the computing nodes 100 may be subject to verifiable computing techniques by which the integrity of the logic applied is remotely verifiable by other computing nodes 100. Examples of such verifiable computing techniques include various homomorphic encryption approaches and replication of the logic, for instance, with more than 1%, more than 10%, more than 50%, more than 80%, substantially all, or all of the computing nodes 100 executing the same logic to produce replicated outputs, and those replicated outputs may be compared to one another to verify that the outputs match, a majority of the outputs deemed authoritative match, or a majority of the outputs under the control of different entities match to verify that the decentralized computing platform 80 is correctly executing the logical rules in on adulterated form. Similar approaches may be applied to verify that persistent state is not subject to tampering by malicious actors controlling a subset of the computing nodes 100, as described in greater detail below.

In some embodiments, the computing nodes 100 may need to communicate with one another over a physical network (like the Internet or a local area network). To this end, some embodiments may implement an address space at the application layer by which computing nodes 100 may determine how to communicate with (e.g., how to address on a network, such as one including a physical media) other computing nodes. In some embodiments, the address space of the computing nodes 100 may be determined without a central authority assigning addresses to the computing nodes 100. In some embodiments, the addresses may be determined based upon a distributed hash table addressing protocol by which an ad hoc network is formed by peer computing nodes 100. In some embodiments, the computing nodes may implement the Kademlia distributed hash table protocol. Or in some embodiments, the address space may be determined with a Chord distributed hash table implementation executed collectively by the computing nodes 100, by way of example.

In some embodiments, a network at the physical layer over which the computing nodes 100 communicate may be untrusted. In some embodiments, each computing node may have a private and public cryptographic key pair like those described above, and the public cryptographic key may serve as a computing node identifier. In some embodiments, the computing nodes may cryptographically sign communications with their private key over the network (and in some cases encrypt with a public cryptographic key of a recipient) and receiving computing nodes may verify the signatures and that messages are not tampered with using techniques like those described above.

In some embodiments, persistent state and other forms of records stored and operated on by the decentralized computing platform 80 may be stored according to a decentralized data addressing protocol. In some embodiments, the addressing may be content based addressing, for instance, records may be stored at an address that is identified by a cryptographic hash of the content of the record. In some embodiments the same or a distinct distributed hash table may indicate how to access various records in the decentralized computing platform. Or some embodiments may implement other types of file systems to address records, such as InterPlanetary File System (IPFS). In some cases, similar verifiable computing techniques may be applied to stored records. For instance, replicated instances of a given record may be stored by multiple computing nodes, such as more than 10%, more than 50%, more than 90%, substantially all, or all of the computing nodes 100, and reported content of records may be compared to determine based upon majority votes like those described above an the authoritative content of a record, such that a malicious entity with control of a single computing node or a plurality of computing nodes 100 less than some threshold, is unable to affect the outcome of a reported content of a record that is read from persistent state of the decentralized computing platform (or nonpersistent state). In some cases, agreement as to record content may be determined by confirming the record is consistent with a cryptographic hash value based on the record, such as one in one or more of the below described cryptographic hash pointers, e.g., along a path through a Merkle tree and along a chain of block header hash values in a blockchain.

In some embodiments, a subset or all of the computing nodes 100 may determine the outcome of logic or the set of rules to be applied in a logical operation, or the state of a record based upon a consensus protocol in which the plurality of computing nodes reach a consensus regarding that logic, result of a logical operation, or state of a record, in some cases based upon replicated instances of the attribute at each of the participating computing nodes 100. In some embodiments, the decentralized computing platform 80 may afford byzantine fault tolerance, both with respect to operations on data and the content of stored records. A variety of consensus protocols may be collectively executed by the computing nodes 100, examples including Paxos, Raft, and the like. In some embodiments, computing nodes may periodically elect a leader computing node, for instance, in response to a previous leader node failing to emit a received heartbeat signal to other computing nodes within a threshold duration of time, and in some cases, that leader computing node may coordinate the operation of other peer computing nodes for some operations.

As noted, the decentralized computing platform 80 may be robust to malicious actors controlling individual or relatively small subsets of the computing nodes 100. However, a malicious actor or collection thereof may attempt to compromise the decentralized computing platform 80 with a majority attack, in which the malicious actor obtains control over more than half of the computing nodes 100 and then drives a consensus that establishes a false result. To mitigate this risk, some embodiments may implement various approaches that make it difficult, computationally expensive, or otherwise costly to consolidate control of the decentralized computing platform 80. For instance, some embodiments may condition a computing node's participation in a consensus algorithm based upon that computing node demonstrating proof of work, proof of storage, proof of stake, or proof of some other item that is difficult to consolidate in a majority attack. For example, some embodiments may cause the computing nodes 100 to each attempt to calculate a hash collision up to some threshold number of digits and accept results from computing nodes 100 that successfully solve the problem, in some cases allocating some form of reward, like cryptographic tokens to those computing nodes that successfully solve the problem. Similar approaches may be applied by which computing nodes may demonstrate proof of storage, for instance, by storing a record and outputting a cryptographic hash of that record combined with a timestamp to demonstrate proof of storage periodically, or a cryptographic hash of the record and some challenge string that is relatively high entropy (e.g., more than 64 bits) and is received by computing nodes in response to a request to demonstrate proof of storage. In some embodiments, computing nodes may demonstrate proof of stake by causing cryptographic tokens to be placed into an escrow wallet address. In some embodiments, computing nodes 100 may each access a physical token that outputs a one-time password used for demonstrating authority to participate in consensus algorithms for some duration of time, such as an output of a linear shift register or RSA token. In some embodiments, for instance, in permission decentralized computing platforms, each computing node 100 may have access to a respective private cryptographic key corresponding to a public cryptographic key, and that computing node 100 may sign messages with the private cryptographic key to demonstrate authority to participate in a consensus protocol or other functionality of the decentralized computing platform. In some embodiments, other computing nodes may determine whether computing nodes seeking to participate in a consensus protocol have successfully demonstrated their authority by verifying the output proof of work, stake, storage, or the like, and reject outputs from those nodes that fail to provide such a demonstration.

In some embodiments, the computing nodes 100 may operate upon various types of information 102 stored by the decentralized computing platform 80. Examples include a directed acyclic graph of cryptographic hash pointers, such as a blockchain or other tamper-evident, immutable, decentralized data stores. Other examples include various scripts in the scripting language of the decentralized computing platform 80 executable by the computing nodes 100, for instance with verifiable computing, such that no single computing node 100 needs to be trusted. In some embodiments, these scripts or programs may be referred to as smart contracts, a term which should not be confused with a contract in law or other financial instrument. Rather, smart contracts refer to programs executable by the decentralized computing platform, which in some cases may be tamper-evident, immutable decentralized programs loaded to the decentralized computing platform by one of the components of the computing environment 70. The smart contracts are contracts in the sense that the logic of the smart contract is immutable in some implementations once loaded to the decentralized computing platform 80 and thus serves as a form of a commitment to a particular body of logic.

The term “immutable” should not be read to require that immutable data be written to a form of physical media that prevents subsequent writes (e.g., a ROM or write-once optical media). Rather, the term “immutable” refers to a data structure that does not support modifications to data once written. In some cases, this feature is afforded by making the data structure tamper evident, e.g., computationally infeasible to modify committed data without rendering the data structure internally inconsistent. In some cases, the data structure computational infeasibility of undetectable modifications may be afforded by chaining the above-described cryptographic hash values, such that verification of tampering consumes less than 100,000^{th} of the computing resources (e.g., in time or memory complexity) of computing resources needed to modify the data structure to be consistent with a modified previously written record.

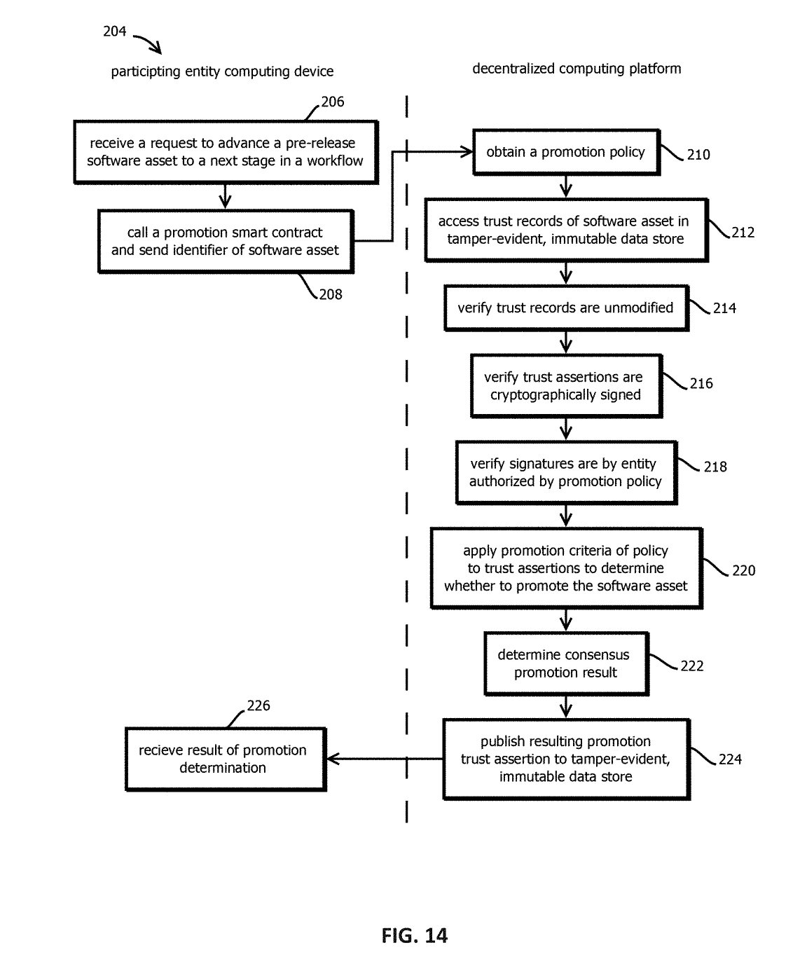

Various examples of smart contracts may be implemented, for instance, an alert smart contract 106, an audit smart contract 108, a promotion smart contract 110, an execution smart contract 112, and an announcement smart contract 114, each of which is described in greater detail below with reference to FIGS. 14 through 18, which describe flowcharts of various examples of these types of smart contracts. In some embodiments, the smart contracts may be stored in the directed acyclic graph of cryptographic hash pointers 104 or otherwise published to this data repository, or in some cases, the smart contracts may be stored in a different tamper-evident, immutable, decentralized data store from that of the data upon which the smart contracts operate.

One example of each of several types of smart contracts are described, but it should be emphasized that there may be, and in some commercial implementations likely will be, multiple instances of each of the types of illustrated smart contracts with variations in the implement to the logic. Further, in some cases, the smart contracts may have properties similar to the software assets described above and, in some cases, may be composed of other smart contracts or invoke or draw upon logic implemented outside of the decentralized computing platform 80. For instance, some smart contracts may interface with the outside world relative to the decentralized computing platform 80 via an oracle 77.

In some embodiments, the smart contracts may be callable by the various components of the computing environment 70. For example, the components in some cases may execute a peer client application of the decentralized computing platform 80 or otherwise send messages to application program interfaces of the decentralized computing platform 80 to call the smart contracts and receive results. In some embodiments, the smart contracts may have an address, for instance, in a data storage address space of the decentralized computing platform 80, like an address corresponding to a cryptographic hash of program code of the smart contracts. In some embodiments, the smart contracts may accept arguments, such as various variables that may be passed to the smart contract and which may be operated upon by logic of the smart contract. In some cases, each smart contract may have a respective application program interface with a schema defined in an artifact of the corresponding smart contract that enumerates arguments that are required, arguments that are optional, default values for arguments, types of those arguments, and the like.

In some embodiments, the directed acyclic graph of cryptographic hash pointers 104 may provide a tamper-evident, immutable, decentralized data store to which the smart contracts are published and to which records access by the smart contracts are published, which in some cases may include output of the smart contracts as well as inputs to the smart contracts. In some embodiments, publishing a record or smart contract to the data repository 104 may include storing all of the information of that record or smart contract (e.g., the program code of the logic of the smart contract that is executed by the computing nodes 100 (e.g., in a virtual-machine of the decentralized computing platform corresponding to a target of byte code into which smart contracts are interpreted) in content of nodes of the directed acyclic graph of cryptographic hash pointers. Cryptographic hash pointers pointing to those nodes include cryptographic hash values (as part of node content of the node that is pointing) that are based on node content (of the node to which is pointed) that includes the stored information, thereby defining a chain of cryptographic hash pointers that becomes increasingly computationally expensive to modify (while remaining internally consistent) in the event of attempted tampering as the chain increases in length or tree increases in size. In some embodiments, a plurality of different directed acyclic graphs of cryptographic hash pointers may store different subsets of the information, may store replicated instances of the information, or in some cases a single directed acyclic graph of cryptographic hash pointers may store all of this information. In some cases, the directed acyclic graph is a sub-graph of a larger graph with a cycle, and in some cases the directed acyclic graph includes unconnected subgraphs.

In some embodiments, publishing information to the directed acyclic graph of cryptographic hash pointers is achieved by storing a cryptographic hash digest of the information in node content of the directed acyclic graph of cryptographic hash pointers. For instance, a given record may be stored outside of the directed acyclic graph of cryptographic hash pointers, but that record and an appended timestamp and address in the data store 104 may be input to a cryptographic hash function to output a cryptographic hash value. That cryptographic hash value (or other hash digest) may be stored as a node content of the directed acyclic graph of cryptographic hash pointers. The published document may then be verified as having been untampered with by recalculating the cryptographic hash value based on the asserted address, time, and record content and comparing the recalculated cryptographic hash value to the cryptographic hash value stored in the directed acyclic graph of cryptographic hash pointers 104. Upon determining that the hash values match, the record may be determined to have not been subject to tampering, or upon determining that the values do not match, the record may be determined to have been tampered with. Further, to verify that the cryptographic hash value in the directed acyclic graph has not been tampered with, some embodiments may recalculate cryptographic hash values along a chain of cryptographic hash pointers to confirm that the recalculated values match those in the directed acyclic graph, thereby indicating the absence of tampering (or upon detecting a mismatch, indicating the presence of tampering).

In some embodiments, a given record may be published to the data repository 102 by storing a portion of the record in node content and storing a cryptographic hash digest based on the rest of the record as node content, with the rest of the record being stored outside of node content, for instance in a file that is accessible via network. In some embodiments, the on-chain portion stored as node content may be a machine-readable portion, such as a portion of key-value pairs in dictionaries encoded as a hierarchical data serialization format, like JavaScript™ object notation (JSON) or extensible markup language (XML). In some embodiments, the off-chain portion may be a human-readable format including unstructured natural language text that describes in prose information of the record. Or in some embodiments, this allocation may be reversed, intermingled, or otherwise differently arranged, which is not to suggest that any other feature herein is not also amenable to variation relative to the arrangements described.

In some embodiments, content of nodes of the directed acyclic graph of cryptographic hash pointers may be verified as having not been subject to tampering by determining whether that content is consistent with one or more chains, or other associative data structures (e.g., trees), of cryptographic hash pointers of the directed acyclic graph. In some embodiments, nodes of the directed acyclic graph of cryptographic hash pointers may include as node content a node identifier (e.g., an address in the graph) that distinguishes a node from other nodes of the graph, identifiers or one or more other nodes of the graph to which a cryptographic hash pointer of that node points, and an associated cryptographic hash values based on node content of those other identified nodes to which the cryptographic hash pointers point (in some cases, the pointing is from one and only one node to one and only one node for adjacent nodes). As additional nodes are appended to the directed acyclic graph, a chain of cryptographic hash pointers may be formed such that each subsequent node includes as node content one or more cryptographic hash values based upon some, and in some cases all of the previously published information published to the directed acyclic graph of cryptographic hash pointers.

The directed acyclic graph of cryptographic hash pointers need not be referred to as a graph, or is having nodes or edges, in program code to constitute a graph, provided that a data structure affords the same or similar functionality, even if that data structure bears different labels. Similar qualifications apply to the policies, assertions, software assets, and records described herein. For instance, graphs may be encoded in objects in object-oriented programming environment, key-value pairs, entries in a relational database, documents encoded in a hierarchical data serialization format, or combinations thereof, without being labeled as graphs.

In some embodiments, to expedite write operations (and in some cases, afford faster reads or verifications of reads), some embodiments may consolidate writes to the directed acyclic graph of cryptographic hash pointers. For instance, some embodiments may form sub-graphs of directed acyclic graphs of cryptographic hash pointers that are collectively appended to an extant, larger directed acyclic graph of cryptographic hash pointers. In some embodiments, the directed acyclic graph of cryptographic hash pointers may include a linked list, tree, or skip list of the sub-graphs. In some embodiments, the sub-graphs may be referred to as blocks and may include 2, 4, 8, 16, 32, 64, 128, 256, 512, 1028, or more or less nodes.

In some embodiments, the appended sub-graphs may be implemented with a particular type of directed acyclic graph that affords relatively fast verification in addressing of published information. In some embodiments, the sub-graphs that are collectively appended may be binary trees, quad trees, radix trees, or the like. In some embodiments, the sub graphs are Merkel trees, such as Patricia trees (lists herein should not be read as necessarily specifying mutually exclusive categories). In some embodiments, information published to the repository 104 may be stored as node content of leaf nodes of a binary tree data structure that is collectively appended to the directed acyclic graph of cryptographic hash pointers upon completion of the tree data structure (e.g., achieving a threshold number of nodes). Or in some cases, intermediate nodes of the tree data structure may include nodes having content in which published information is stored.

In some embodiments, the directed acyclic graph of cryptographic hash pointers 104 is formed by a chain of cryptographic hash pointers between nodes that include as node content a root node of an appended tree data structure or cryptographic hash value based on node content of a root node, in some cases further including a unique identifier of the tree in the chain and a timestamp, for instance in a block header of a block in a blockchain. In some embodiments, an initial node in the chain may include a randomly selected, relatively high entropy value that serves as a source of entropy for each subsequent entry in the chain. In some embodiments, to afford faster navigation along the chain, some chains may include a skip list or index of blocks or entries in blocks.

Various trust records may be published to the directed acyclic graph of cryptographic hash pointers 104. In some embodiments, these trust records may include one or more trust assertions pertaining to a software asset. In some embodiments, the trust records may be indexed by software asset, such as by a unique software asset identifier, like a cryptographic hash of the content of a software asset, or a name of a software asset that persists across versions and a version identifier. In some cases, different trust assertions may be made by different entities, and those different entities, in some cases, may be uniquely identified and in some cases may cryptographically sign the trust assertions with respective private cryptographic keys. In some cases, determinations of whether different entities will trust a software asset may be based upon some or all of the trust assertions, in some cases with different entities applying different criteria as defined in various trust policies like those described below.

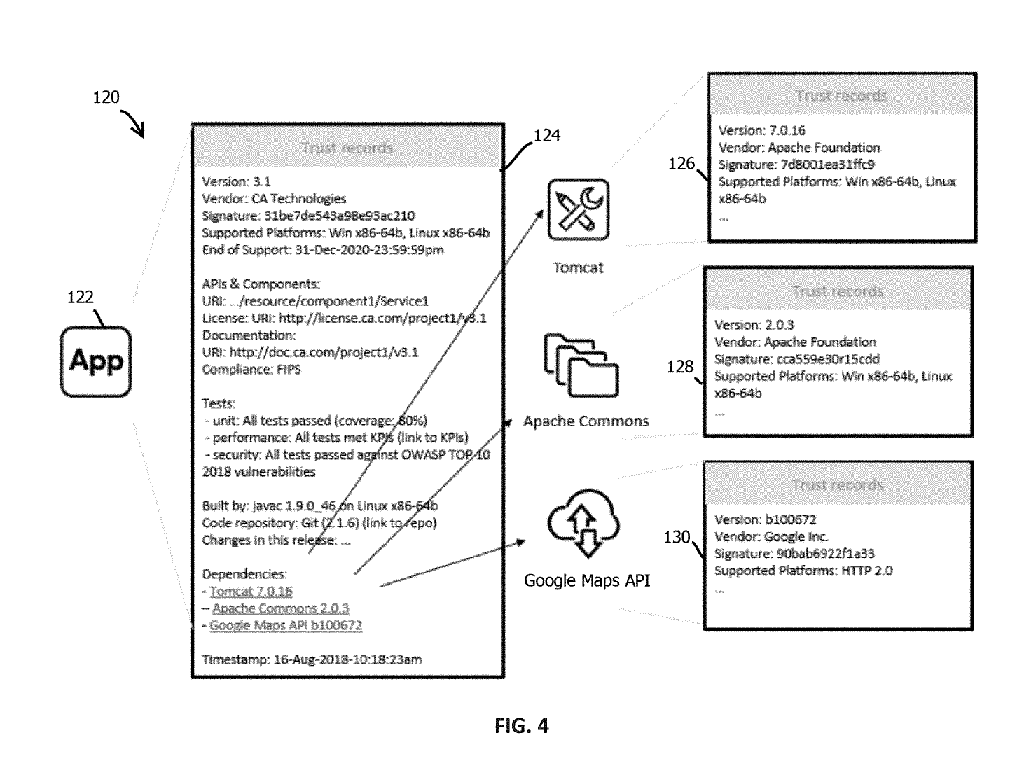

FIG. 4 shows an example of a trust corpus 120 pertaining to a software asset 122. In some embodiments, the trust corpus 120 may include a trust record 124 pertaining to a gateway software asset and a plurality of trust records 126, 128, and 130 pertaining to constituent software assets of the software asset 124, for instance, pertaining to libraries, frameworks, application program interfaces, modules, and the like having functionality invoked by the software asset to which trust record 124 pertains. By way of example, some of these relationships may be enumerated in a dependency section of the trust record 124, and those relationships may correspond to edges in the constituency graph described above with reference to FIG. 1. In some cases, a single software asset may have a plurality of different trust records, such as different versions of a trust record, or a given version may be distributed among multiple documents. In some cases, the trust records may be arranged in a hierarchical format, for instance a hierarchical data serialization format, like JSON or XML. In some embodiments, the trust records may include key-value pairs like those present in the illustrated example and delimited by reserved terms (like a colon) with end of line characters delimiting key-value pairs, and in some cases, including a timestamp indicative of when the trust record was created (e.g., when the information therein was ascertained, when the record was formed, or when the record was signed).

In some embodiments, the trust records may be stored in the directed acyclic graph described above and thus, may be tamper-evident, immutable decentralized records. Accordingly, as referents of trust assertions evolve over time, for instance, when new information becomes available about a software asset, new versions of trust assertions or trust records may be written to the data store 104, and in some cases, indexes identifying those new records may be updated to reference the newer version (rather than overwriting the older information). In some cases, the various constituent components of the computing environment 70 described above may reference such an index to identify trust records. In some embodiments, the index may be stored in the data store 104 as well. (Or some embodiments may operate on mutable records.)

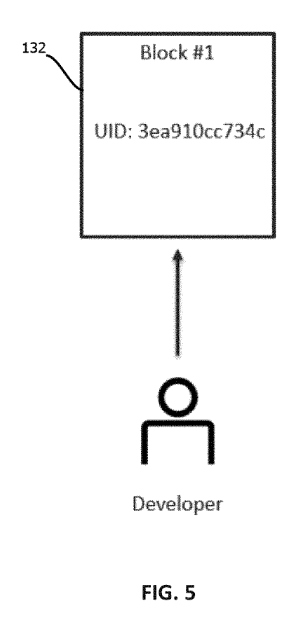

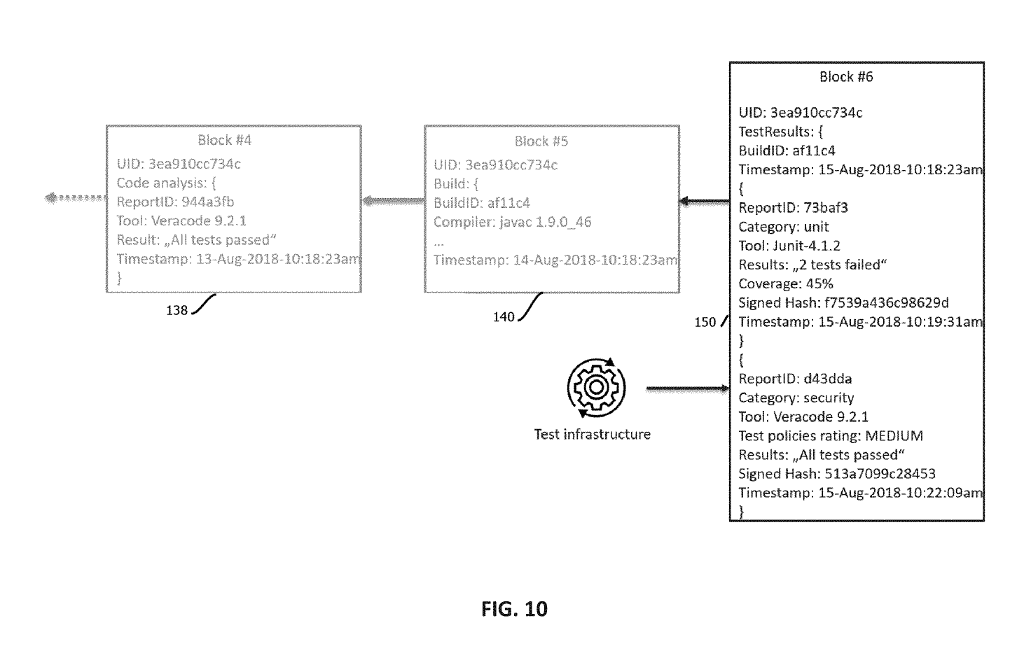

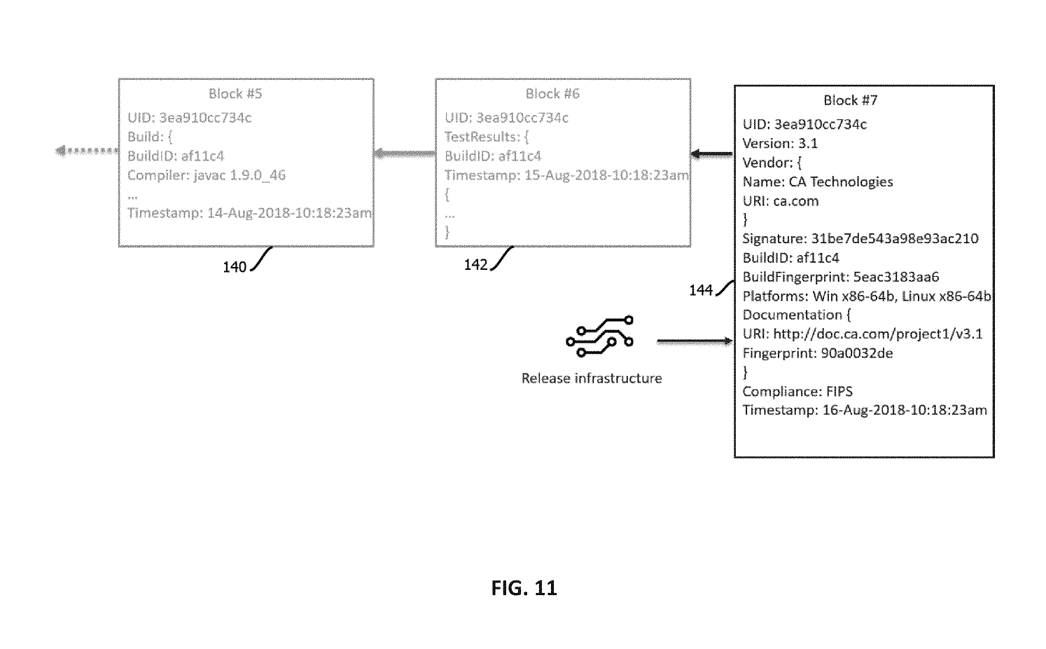

FIGS. 5 through 11 schematically depict the evolution of a trust record for a given software asset. In some embodiments, trust records may be encoded as a linked list or other associative array of trust assertions or constituent trust records to which new trust assertions or trust records are appended over time as the available information about a software asset increases and evolves. In some embodiments, this process may include instantiating a new software asset, as indicated by block 132 in FIG. 5. In some embodiments, the newly instantiated software asset may be assigned a global unique identifier, for instance, in a namespace of software assets in the above-describe computing environment 70. In some cases, a GUID may be assigned by calling a smart contract that returns a GUID determined by the smart contract to not conflict with extant names. In some cases, the resulting initial trust record having the unique identifier may be written to a first block (which may be part of a longer block chain). In some embodiments, writing the trust record to the block may include publishing the trust record, for example, by writing the illustrated trust assertion with the unique identifier to content of a leaf node of a Merkel tree of the block. In some embodiments, a developer may instruct their computing device to instantiate a new software asset by interfacing directly with, for example, a smart contract configured to instantiate new trust records for new software assets, or in some cases, a version control repository, like Git™, may be configured to automatically create the trust record 132 responsive to a developer requesting to create a new repository for new software asset, in some cases cryptographically signing the record 132 on behalf of the version control application, the developer, or both.

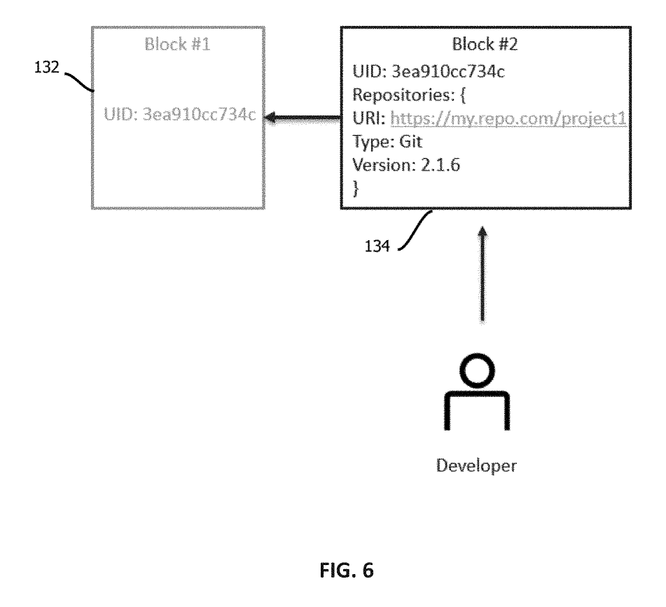

Next, in this example use case, the developer may form a repository for the software asset in a version control system and create a corresponding new trust record 134, as shown in FIG. 6. Again, in some cases, this added trust record 134 may include an identifier of the previous trust record 132, such as an address in a blockchain at which the other trust record is published. In some embodiments, the added trust record 134 may reference the same unique identifier and identify the repository, type of repository, and version of repository, as indicated in FIG. 6.

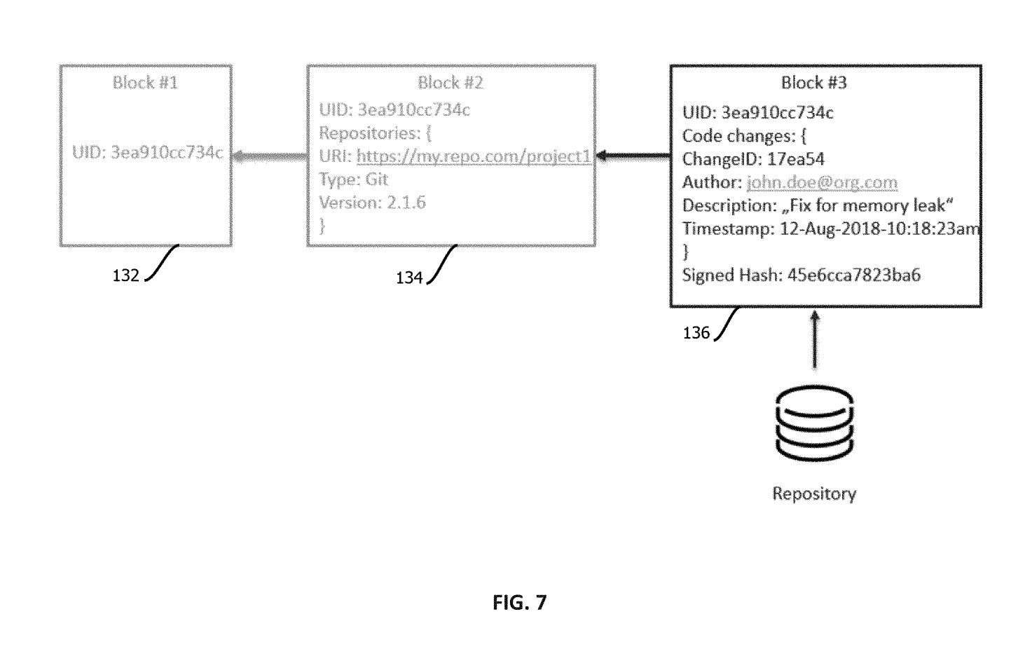

Next, as shown in FIG. 7, upon a developer committing code changes to the software asset to the repository, a new trust record 136 may be published. In some embodiments, the new trust record 136 may include a reference to an address of the previous trust record 134 in the blockchain. In some embodiments, the trust records 132, 134, 136 may be written consecutively to a directed acyclic graph of cryptographic hash pointers, or in some cases, various other trust records may be written between these trust records, such as other trust records pertaining to other software assets. In some embodiments, trust records like trust record 136 may include a cryptographic hash of the content of code of the software asset, of a set of changes to the code of the software asset, and various other key-value pairs like those illustrated. In some cases, a trust assertion may be verified to apply to a software asset by comparing a signed cryptographic hash of the software asset in the trust record to a recalculated cryptographic hash of the software asset in question. Upon determining that the cryptographic hash values matched, the trust record may be verified as applying to that software asset, or upon the cryptographic hash values failing to match, the trust record may be determined to not apply to the software asset or may be determined that the software asset was modified subsequently. This and the other writes may be cryptographically signed by entities causing the writes, e.g., the developer, an IDE, the repository, or all of these entities.

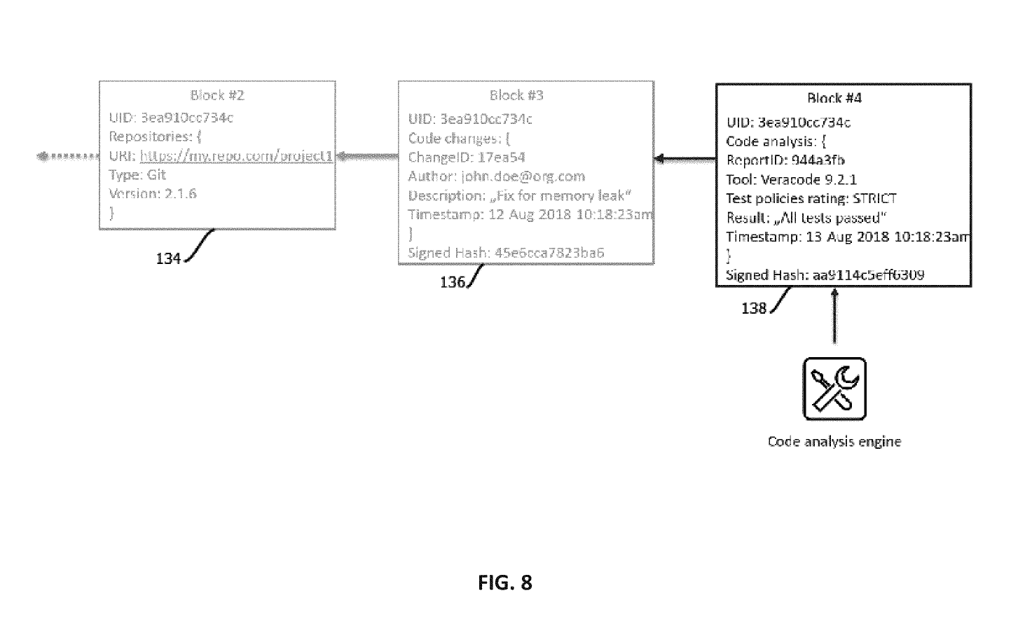

Next, as shown in FIG. 8 an entity analyzing the code commit may publish a trust record 138 of the result of the analysis, which may include a reference to an address of the previous trust record 136 in the blockchain. In some cases, each trust record may include the above-describe cryptographic hash digest of the code of the software asset to which the trust record pertains to afford the above-describe verification features. In some embodiments, the trust record 138 may be cryptographically signed by an entity that analyze the committed code of the software asset described above. In some embodiments, the entity may be a human reviewer or an application configured to perform static or dynamic analysis of code of the software asset, and in some cases, various trust assertions therein or the entire trust record may be cryptographically signed with a private cryptographic key of that entity. In some cases, different entities may sign different trust assertions. In some cases, multiple entities may sign the same trust assertion (e.g., a developer, their organization, and a software application that performs an analysis).

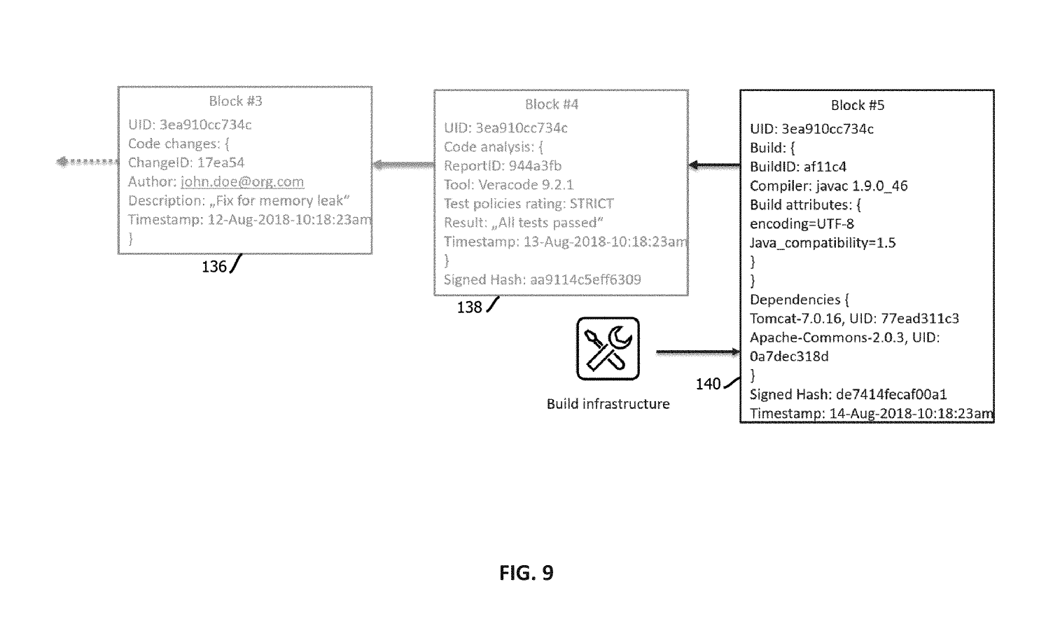

Next in this example use case, as shown in FIG. 9, the tested software asset may be processed with build infrastructure, which in some cases may create an additional trust record 140 with a reference back to the address of the previous trust record 138. In some embodiments, the build infrastructure may be configured to enumerate dependencies in a manifest, for instance, by parsing code of the software asset to identify references to other software assets and adding those identified software assets to a list of dependencies, in some cases including unique identifiers of the software assets in the address space of software assets, such that trust records of those dependency constituent software assets are identifiable.

In some cases, a trust record corpus may span software assets, e.g., when the edge in the constituency graph is one of identity, like when a source code version is compiled or interpreted to for a version executable on a target platform. In some cases, the references to the software assets may include identifiers of versions, providers, names that are persistent across versions, and the like. In some embodiments, the build infrastructure may further include identifiers and versions of applications by which the software asset is built, such as identifiers and versions of compilers, interpreters, orchestration tools, tools by which virtual machine images and container images are composed, and the like. In some embodiments, the build infrastructure may further identify target computing environments, like target operating systems, virtual machines, container engines, and the like. In some embodiments, the build infrastructure trust record may further include other configuration settings of the applications by which software assets are built into forms suitable for subsequent testing and deployment. In some embodiments, the trust record by the build infrastructure may similarly include a cryptographic hash digest of the software asset, a timestamp, and in some cases may be cryptographically signed by a private key of the application that is transforming the software asset into the built state.

In some embodiments, post build test infrastructure, for example, executed in a staging portion of a software development pipeline may create additional test records, for instance, by testing and recording and publishing test results of tests on the built software asset. In some embodiments, several tests may be applied and different tests may be recorded in different or the same trust record, for instance with different sets of trust assertions. In some embodiments, the test infrastructure may include results of human testing as well as results of test applications, such as dynamic test applications, like those examples described above. In some embodiments, the test trust records may include configurations of the tests, identifiers of the tests, identifiers of the test applications, identifiers of versions of the test applications, timestamps of the tests, cryptographic hash digests of the code of the software asset being tested, cryptographic hash digests of the code of the test application, descriptions of environments in which the tests are applied, test results, and the like. As with the examples above, these different sets of trust assertions in trust records may be cryptographically signed by the entity performing the tests, for instance, with a private cryptographic key of that entity or proxy like a certificate authority according to the techniques described above. And as with the examples above, the test infrastructure's trust record 150 may include an identifier of an address of the previous trust record 140 in the blockchain.

Next in this example, the software asset may be determined to have satisfied the tests and be suitable for deployment. In some embodiments, deployment may be implemented with release infrastructure, which may create additional trust records 144. In some cases, the release infrastructure may include the various examples described above with reference to FIGS. 2 and 3 and may publish a trust record including an identifier of an entity releasing the software asset, a cryptographic hash digests of the released software asset, a cryptographic hash digests of various build parameters, identifiers of target platforms, locations of documentation and other artifacts, and results of various audits, along with the timestamp. In some embodiments, at this or various other stages, information of previous trust records may be summarized and a summary may be published as a trust assertion. For example, the result of applying various policies to previously published trust assertions may be published as a trust record to expedite trust determinations and avoid the need to go back and reapply the policy to re-create the determination in every subsequent determination of trustworthiness. Examples are described below and include summaries such as, “Security Policy XYZ, version 123: compliant,” or “approved for release: true.”

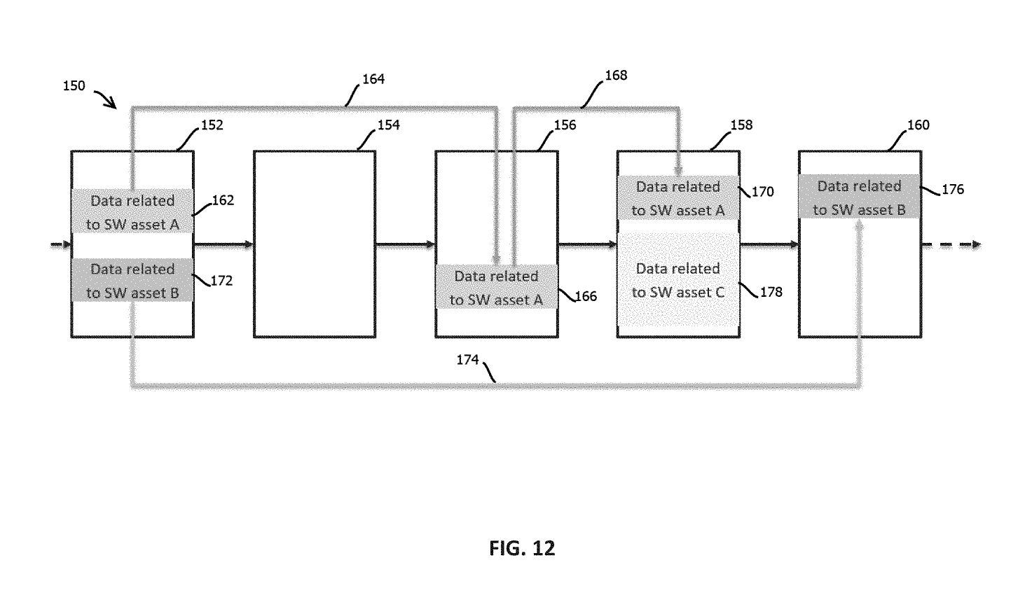

As mentioned, a linked list or other associative data structure of trust records pertaining to a software asset may not necessarily be stored consecutively in the blockchain or other nodes of a directed acyclic graph of cryptographic hash pointers. In some cases, entries for different software assets on different linked lists (or other trust record graphs) may be interspersed between one another on a blockchain, in some cases with more than 10, more than 100, more than 1000, more than 10,000, more than 100,000, or more than 1 million distinct linked lists of different software assets being stored on the same blockchain. An example of this arrangement is shown in FIG. 12 with a blockchain 150 having a sequence of blocks 152, 154, 156, 158, and 160 stored in a sequence, for instance, with nodes having as node content timestamps, Merkel root cryptographic hash values, and cryptographic hash values based on node content of block headers to which they point. In this example, two different linked lists of trust records pertaining to two different software assets may be stored. For example, a most recent trust record for software asset A 162 may include an identifier of a previous trust record for the software asset A, which may be characterized as an edge 164 in a trust-record graph. That edge 164 may point to an address in the blockchain of earlier data related software asset A in record 166, which may include another edge 168 in the trust-record graph that identifies an address in the blockchain of trust record 170. Similarly, software asset B may include a most recent trust record 172 with an edge 174 in a different software trust-record graph that identifies an address of trust record 176.

In some embodiments, to expedite reads, some embodiments may include an index maintained either inside or external to a blockchain or other tamper evident immutable decentralized data store that identifies addresses of the blockchain or other namespace of the data store to which each trust record of a software asset is published. In some embodiments, the index may be referenced to select a set of addresses based on an identifier of the software asset, and each identified record associated with a unique identifier of a software asset may be concurrently retrieved from the blockchain, or in cases in which a hash digests is published to the blockchain and the trust record is report restored stored elsewhere, the index may identify address of both, and hash digests may be concurrently retrieved, along with the remotely stored records. This is expected to expedite retrieval of trust records relative to systems that increment along a linked list sequentially reading, which is not to suggest that such an arrangement is inconsistent with some embodiments or the any other description herein is limiting.

In some embodiments, the index may associate a unique identifier of a software asset, like a cryptographic hash digest of the code of the software asset, with a plurality of addresses on a blockchain or other directed acyclic graph of cryptographic hash pointers. Each of those listed addresses may be an address to which a corresponding trust record of the identified software asset is published. In some embodiments, various attributes may be associated with the different addresses to which the trust records are published, such as attributes indicating whether the court the corresponding trust record has been superseded by subsequent trust record, a type of the trust record, such as a stage in a software development lifecycle, a date of the trust record, and the like. In some embodiments, some systems may filter which trust records are retrieved based on these values, for instance, only selecting trust records pertaining to post-build testing, or only retrieving trust records pertaining to audits.

In some embodiments, certain indexed trust records may be published (in replication) to a cache tamper-evident, immutable decentralized data store, such as a data store having a smaller amount of memory that is higher performance, such as an in-memory database or a geographically local database. Some embodiments may attempt to retrieve trust records first from the higher performance cache before going to a lower performance tamper-evident, immutable, decentralized data store, in some cases based upon identifiers of the different published instances in an index like that described above.

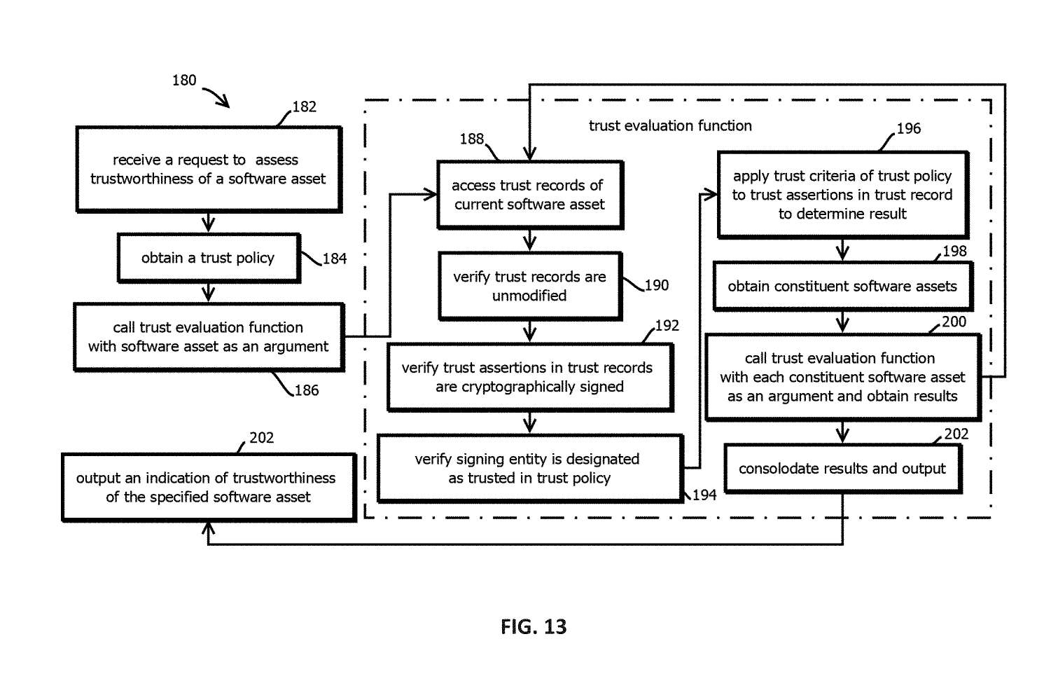

FIG. 13 is a flowchart depicting a process 180 by which trustworthiness of a software asset may be determined. In some embodiments, the process 180 obtains trust transitive closure of the software asset by determining trustworthiness of every constituent software asset in a constituency graph like that described above with reference to FIG. 1.

Some embodiments record information about a software supply-chain in a blockchain (or other graph of cryptographic hash pointers). Units of documented code may (e.g., recursively) include dependencies (including third-party API's) and modules of an application. A blockchain may include or verifiably document for each such constituent of the application relatively fine-grained information about versions and state thereof in a software-development life-cycle (SDLC) workflow. Some embodiments may further include for each version or record of state in the SDLC a cryptographically signed hash digest of the version or record of state (or the version/record itself), signed using PKI by a participant of the system. To facilitate low-latency reads, some embodiments may execute the blockchain's consensus algorithm on a permissioned network, substituting proof of authority or stake for proof of work. To facilitate broad adoption, some embodiments may integrate permissioned and permissionless implementations. (It should be emphasized, though, that not all embodiments necessarily provide all of these benefits or the other benefits described herein, which is not to suggest that any other description is limiting.)

In some embodiments, the process 180 may be executed by one of the above-described components of the ecosystem 70. In some embodiments, the process 180 or subsets thereof may be executed by different ones of these components, for instance, with some operations performed by a computing device attempting to determine whether a software asset is trustworthy and other portions determined by a smart contract that makes the determination on behalf of the computing device. Or in some cases, a subset of the trustworthiness determinations may be offloaded to a smart contract, such as verification of signatures or absence of tampering with records, while other portions may be determined outside of smart contract, for instance, comparing trust assertions verified by the smart contract with trust criteria of a trust policy. Or in some cases the entire process 180 may be executed by a given computing device externally to the decentralized computing platform described above based upon records stored in the above-described tamper-evident, immutable decentralized data store.

In some embodiments, the functionality of the process 180, and the other functionality described herein, may be implemented with instructions stored on a tangible, non-transitory, machine-readable medium, such that when those instructions are read, the described functionality may be effectuated.

In some embodiments, the process 180 includes receiving a request to assess trustworthiness of a software asset, as indicated by block 22. In some embodiments, the request may be received from an operating system configured to determine whether software assets are trustworthy before allowing the software assets to execute. In some embodiments, the request may be a request from a remote computing device seeking to determine whether an application program interface exposes functionality implemented with a trustworthy software asset. In some embodiments, trustworthiness may be determined in the course of various other assessments of software, such as determining whether software satisfies various regulatory constraints, audit requirements, security requirements, enterprise network policies, and the like, with various more specific examples described below with reference to FIGS. 14 through 18.

In some embodiments, the process 180 includes obtaining a trust policy, as indicated by block 184. In some embodiments, the trust policy may be identified in a request to assess trustworthiness, for instance, in association with an identifier of the software asset, like a hash digests of the software asset, or code of the software asset itself In some embodiments, different entities may each maintain a plurality of different trust policies for various purposes. For instance, one trust policy may be applied to software assets executed within a secure network of an entity, while a different trust policy may be applied to software assets executed outside of that secure portion of a network. Similarly, different trust policies may be applied for client-side executable software assets and server-side executable software assets. In some embodiments, different trust policies may be applied based upon computing resources, like data, to which software assets have access. In some embodiments, a single trust policy may include criteria by which subsets of trust criteria in the trust policy are selected and designated as being applicable to a given context, rather than having multiple different trust policy documents, and embodiments may evaluate these criteria and determine which portions are applicable to a specified context.

In some embodiments, the trust policy may be encoded in a domain specific programming language by which trust criteria are expressed. Examples of trust criteria include whitelists or blacklists of values in key-value pairs of trust assertions. Other examples include regular expressions applicable to values in key-value pairs of trust assertions, with values responsive to the regular expression being designated in the trust policy as satisfying or not satisfying the criteria. In some embodiments, trust criteria may include ranges of values, such as trust criteria indicating that a version number of software asset may be must be above some threshold value, or an amount of computing resources consumed by a software asset must be less than some threshold value. In another example, trust policies may specify that performance attributes of a software asset must satisfy some threshold response latency or load capacity as demonstrated by specified test applications.

In some embodiments, trust criteria may specify parameters of a trust model by which a trust score is calculated, and the trust policy may include a threshold trust score for which values below the trust score are determined to be not trustworthy and values above the trust score are determined to be trustworthy (or the relationship may be reversed for scoring systems in which lower values indicate greater trust). In some embodiments, the parameters may be adjustable parameters of a machine learning model trained on labeled historical examples of trustworthy and untrustworthy software assets, for instance, by iteratively adjusting model parameters to reduce an amount of error between predictions of the model and labeled trustworthiness determinations on the training set. Examples include trained decision trees or classification trees, neural classification networks, support vector machines, and clustering algorithms like DB-SCAN trained to cluster historical examples into trustworthy and untrustworthy clusters. In some cases, natural language processing techniques may be applied to text of trust assertions to classify software assets or individual trust assertions, e.g., latent semantic analysis may be applied to labeled training sets of historical trust records to classify collections of n-grams as indicative of trustworthiness or the absence thereof, or latent Dirichlet allocation may be applied to a corpus of historical trust records to group those trust records into categories indicative of trustworthiness of new software assets.

In some cases, the request may explicitly identify a trust policy, or the request may include attributes by which a trust policy may be selected, such as an entity requesting the trust determination, an identifier of a computing environment or computing resources accessed by the software asset, or the like, and the trust policy may be selected based on these attributes. For instance, trust policies may be associated with criteria by which applicability is determined with a rules engine.

In some embodiments, the trust policy may be published to the above-described tamper-evident, immutable, decentralized data store, for instance, in a record cryptographically signed by an entity that purports to promulgate the trust policy, and some embodiments may access these records to verify that the trust policy has not been subject to tampering and is promulgated by an acceptable entity.

Some embodiments may call a trust evaluation function with the software asset as an argument, such as an identifier of the software asset, as indicated by block 186. In some embodiments, the function call may also include is an argument the trust policy. Arguments may be passed either as distinct copies or as references to values. In some cases, the function is a smart contract or is executed by another computing device executing a component of environment 70 described above.

In some embodiments, the trust evaluation function may access trust records of a current software asset identified as an argument of the function call, as indicated by block 188. In some embodiments, this may include accessing the above-describe published trust records in the tamper-evident, immutable, decentralized data store, which in some cases may be implemented with the directed acyclic graph of cryptographic hash pointers 104. In some embodiments, accessing the trust records includes accessing a hash digests of the trust records stored as node content of such a data store and accessing the corresponding trust record from a repository external to the tamper-evident, immutable, decentralized data store. In some embodiments, such externally stored trust records may be stored in a document repository, a local file system, and a decentralized file system, like that provided by the interplanetary file system (IPFS) protocol, or the like.

Some embodiments may then verify that the trust records are unmodified, as indicated by block 190. In some embodiments, this may include comparing cryptographic hash digests of the trust records stored in the tamper-evident, immutable, decentralized data store, with recalculated cryptographic hash digests of the access trust record to determine that the values match, thereby indicating that the trust record is unmodified (or vice versa). Some embodiments may further verify that the values published to the tamper-evident, immutable, decentralized data store have not been subject themselves to tampering with the above-describe techniques by which a chain of cryptographic hash pointers may be recalculated to verify that they match those present in a directed acyclic graph of cryptographic hash pointers, which in some cases, is replicated in part on a plurality or all nodes of a decentralized computing platform.

Some embodiments may verify that trust assertions in the trust records are cryptographically signed, for instance, with the above-described signature verification process, as indicated by block 192. In some cases, different trust assertions in a given trust record may be cryptographically signed by different entities, and in some cases multiple entities may cryptographically signed a given trust assertion.

Some embodiments may verify that a signing entity of the cryptographic signature is designated as a trusted entity in the trust policy for purposes of the signed trust assertion, as indicated by block 194. In some embodiments, this may include identifying whether the trusted entity is among a whitelist (i.e., permitted) or blacklist (i.e., not permitted) of trusted or un-trusted entities designated in the trust policy. In some cases, a proxy, like a certificate authority may serve as an entity authorized to designate others as trustworthy for various purposes designated by the trust policy.

Some embodiments may then apply trust criteria of the trust policy to trust assertions in the trust record to determine a trustworthiness result, as indicated by block 196. In some cases, this may include determining whether each of the above-described types of criteria are satisfied by values in the trust assertions. In some cases, this may include inputting the trust criteria and trust assertions into a rules engine configured to apply the criteria to the assertions and indicate for each criteria whether the criteria is satisfied. In some cases, this may include inputting the values to a trained machine learning trust model to output a trust score and comparing that trust score to a threshold trust score to determine a result. In some cases, the result may be a binary value that indicates whether the software asset is to be trusted. In some cases, the result may be a plurality of binary values corresponding to different aspects of trustworthiness, for instance, indicating whether the software asset has been properly audited, the software asset is subject to documented security concerns, the software asset is performant, the software asset is from a trusted entity, and the like, e.g., in some cases with one value for each trust criteria. In some embodiments, the result may be a score over some range, like an 8-bit value, for one or more of these types of results.

Some embodiments may further obtain constituent software assets of the current software asset, as indicated by block 98, such as software assets adjacent the current software asset in a constituent constituency graph. In some cases, these software assets may be obtained (e.g., their identifier may be obtained, thereby providing the software asset by reference) from the trust record, for instance in a list of dependencies. In some cases, these constituents offer assets may be obtained by parsing code of the software assets to identify patterns indicative of calls to other software assets or invocation of functionality of other software assets. In some embodiments, a plurality of adjacent constituent software assets may be identified, such as more than 5, more than 10, or more than 50.

Some embodiments may recursively traverse the constituency graph to explore constituency graphs of arbitrarily large sizes. Some embodiments may execute a depth first or breadth first search of the constituency graph to visit every node of the constituency graph and identify all software assets having functionality invoked by the software asset for which a request to assess trustworthiness is received. To this end, some embodiments may call the trust evaluation function by operation of the trust evaluation function itself (e.g., with a recursive function call), in multiple function calls with each constituent software asset identified as an argument in the function call, and then obtain results from those function calls, as indicated by block 200. In some embodiments, the parameters described above as being passed to the trust evaluation function may be passed through the function call 200. In some embodiments, the function call in block 200 may further include a list of software assets that have already been evaluated, and some embodiments may determine whether a software asset has already been evaluated before performing another function call in block 200 or reassessing trustworthiness for that constituent software asset with reference to this list (e.g., upon determining that a current software asset is not designated by the list as having been evaluated). For example, some software assets may call other software assets that in turn call certain functionality in the original software asset, thereby creating a cycle in a constituency graph. Some embodiments may maintain a list of visited software assets to mitigate the risk of an infinite loop of trust evaluation.

Some embodiments may then consolidate results from the function calls in block 200 with the results otherwise obtained by the trust evaluation function and output the consolidated results, as indicated by block 202. Consolidating results may take various forms, including determining whether any result indicates that any constituent software asset or the software asset itself lacks trustworthiness. Consolidating results may further include forming a call graph stack trace for a software asset in which constituent software assets deemed to lack trustworthiness or otherwise produce various results are associated with a path through the constituency graph, like a call graph to the constituent software asset exhibiting the trustworthiness attributes at issue. For example, an example of a call graph stack trace may identify a web browser, then an operating system in which the web browser executes, then a driver operating within the operating system, and then an instance of firmware interfaced with that driver known to have a security vulnerability and flagged in the application of trust criteria in block 196. In some embodiments, consolidated results may include a plurality of such traces and outputs, or some embodiments may apply various rules specified by the trust policy to consolidate results, such as a rule instructing that a software asset should be designated as untrustworthy if any constituent software asset is deemed trustworthy or any constituent software asset of a particular type is deemed untrustworthy.

In some embodiments, the process 180 may include receiving an output from the trust evaluation function and outputting an indication of trustworthiness of the specified software asset, as indicated by block 202. In some embodiments, this may include outputting a signal that instructs a computing device to not execute the software asset, to only execute the software asset within a virtual machine or other sandboxed environment, or to deny access to various computing resources to the software asset, for instance limiting which databases or files or computing devices a software asset is permitted to access. In some embodiments, outputting the indication may include causing a computing device to log an alarm, display a message describing the output, for instance with the above-described stack traces, sending an email, sending a text message, or otherwise sending a message to an address specified in the trust policy.

FIG. 14 is a flowchart depicting an example of a process 204 configured to determine whether to promote a software asset to a next stage in a software development lifecycle based upon the above-described cryptographically signed trust records stored in a tamper-evident, immutable, decentralized data store, in some cases with a promotion smart contract.

Some embodiments may process steps (including conditional logic) of a pre-release software development process in a smart contract. Code of the smart contract and outputs may be verified with a consensus algorithm executing on a permissioned or permissionless collection of hosts on a network, which is potentially a different set from the hosts implementing the above-described blockchain. In some embodiments, the smart contract may read and write state in the blockchain, or other records may be accessed, e.g., in another immutable, non-tamper-evident repository, or a tamper-evident mutable repository. At each stage (e.g., static analysis, unit tests, code review, compiling, performance testing, functional testing, etc.), logic of the smart contract (or a stage-specific smart contract) may determine whether criteria of the respective stage are satisfied and, in some cases, update a record of development state and cryptographically sign a record of change in state. In some cases, the smart contracts may ingest cryptographically signed results from other entities (e.g., human reviewers or testing applications), or the smart contracts themselves may implement the logic by which code is analyzed.

In some embodiments, the process 204 may be executed recursively for each node through a constituency graph and may be characterized as a species of the process 180 of FIG. 13, or in some cases, the process 204 may be executed in a different manner. In some embodiments, the process 204 may be executed on only a current software asset or only that software asset and adjacent software assets in a constituency graph. In some embodiments, the process 204 may include functionality allocated in the manner shown between a participating entity computing device and a decentralized computing platform, like those described above. In some embodiments, the participating entity computing device may be a developer's computing device operated by developer requesting to promote a software asset to a next stage in a software development lifecycle workflow. Or in some cases, the participating entity computing device may be a computing device on which a software repository, develops tooling, release infrastructure, or the like is hosted, and the request to promote may be generated automatically in the course of operations by these computing devices are otherwise advancing or seeking to advance the software asset to a next stage. In some embodiments, the stages through which the software asset is advanced may be pre-released stages, such as stages during development, static test, code review, dynamic test, building, staging, audits, and the like as described above with reference to FIG. 2. In some embodiments, the functionality allocation in the process 204 may be different from that depicted, which is not to suggest that any other description is limiting. In some embodiments, all of the illustrated functionality may be executed by the participating entity computing device, the decentralized computing platform, or a different arrangement in which any permutation of operations are allocated to one of these computing systems or other computing systems may be implemented.

In some embodiments, the process 204 begins with receiving a request to advance a pre-released software asset to a next stage in a software development workflow, as indicated by block 206. In some embodiments, the request may be an explicit request entered by a developer, or in some cases, the request may be programmatically generated, for instance based upon a developer request submitted to other tooling used in the software development lifecycle. Examples include a developer request to commit to a code repository, a pull request, a request to build, execution of static analysis tests, execution of dynamic analysis tests, and the like.

In response to receiving the request, some embodiments may call a promotion smart contract and send an identifier of the software asset, as indicated by block 208. For example, code of the software asset, a cryptographic hash digest of the code of the software asset, an address of the software asset at a network accessible location, or the like may be passed as an argument to the promotion smart contract. In some embodiments, calling the promotion smart contract may include determining an address of the promotion smart contract in the decentralized computing platform in the manner described above. In some embodiments, calling the promotion smart contract further includes including in the call arguments by which various policies may be identified in the manner described above, such as policy specific to an entity making the request and a use case or type of use case for the software asset.

In some embodiments, the promotion smart contract may execute on the decentralized computing platform in the manner described above. Some embodiments may obtain a promotion policy, as indicated by block 210. In some embodiments, this may include accessing a plurality of policies, selecting among those policies based upon arguments in the call to the promotion smart contract, and verifying a cryptographic signature of the policy. In some embodiments, consistent with the phrase “passing an argument,” and similar phrasing, arguments may be conveyed to the smart contract in a variety of different ways, including passing values by reference, sending commands that cause the promotion smart contract or other smart contract to request or otherwise retrieve a value, and providing values by which the argument is determined.

Some embodiments may access trust records of the software asset in a tamper-evident, immutable, decentralized data store, as indicated by block 212. In some embodiments, this may include executing the above-described read operations, in some cases interrogating records identified by the above-described index to retrieve each node of a trust-record graph. Some embodiments may then verify that the trust records are unmodified, as indicated by block 214, for instance, by verifying that the trust records are consistent with other cryptographic hash values based on those trust records in the tamper-evident, immutable, decentralized data store in the manner described above.

Some embodiments may then verify that trust assertions in the trust records are cryptographically signed, as indicated by block 216, for instance, in the manner described above.

Some embodiments may then verify that signatures are by an entity authorized by the promotion policy, as indicated by block 218, for instance, applying the criteria described above by which authority of entities may be determined. In some embodiments, the entities may be defined by the promotion policy itself, or a proxy may be identified by the promotion policy, for instance, a certificate authority, and the proxy may sign the record to authorize on behalf of other entities vetted by that proxy.

Some embodiments may then apply promotion criteria of the promotion policy to trust assertions of the software asset to determine whether to promote the software asset, as indicated by block 220. Some embodiments may execute a rules engine in this and the other examples of applying criteria to trust assertions, and the rules engine may parse criteria from a policy, identify, and select trust assertions specified by a predicate of the criteria, and then evaluate the criteria against the selected trust assertions. In some embodiments, the rules may be encoded in a domain specific programming language and may include, for example branches, for example expressed in decision trees (of either the machine learning variety or in the sense of if-then-else statements that are hand coded). Some embodiments may input the trust assertions and criteria to a rules engine of the smart contract like that described above, or input the trust assertions to a trained machine learning model trained in the manner described above on a training set having labeled examples of software assets suitable for promotion at a given stage and not suitable for promotion. Or in some cases, (here and with the other smart contracts herein) a rules engine and machine learning model may be pipelined, in some cases, with multiple stages of each interspersed along a pipelined workflow.

Examples of promotion criteria include a criteria that requires that a pull request be approved in a trust assertion that is cryptographically signed with a private cryptographic signature of a different developer from a developer that submitted a pull request, and in some cases from a developer having a specified title or role in organization, for instance, as specified in an organizational chart defining permissions and roles and stored in the tamper-evident, immutable, decentralized data store described above. Some embodiments may retrieve an organizational chart or other definition of roles and permissions in the course of applying such criteria, or respective addresses of records about entities associated with the public/private key pair may contain roles and permissions.

Another example includes promotion criteria (the plural criteria is used herein broadly to encompass both a single criterion and a plurality of criteria) that requires a static test be applied to source code of the software asset and a positive passing result be expressed in a trust record that is cryptographically signed with a private cryptographic key of a static test application of a specified vendor, with a specified version, with a specified test configuration.

Another example of a promotion criteria includes promotion criteria that requires a software asset be built targeting a specified target platform, for instance, a requirement that the software asset compiled targeting a version of Linux™ with greater than a threshold version number or interpreted targeting a specified version of the Java™ virtual machine.

As mentioned above, in some cases, smart contracts may be executed with verifiable computing techniques, including replication and consensus. Some embodiments may execute the promotion smart contract on each of the above-described computing nodes 100 of the decentralized computing platform 80 described above with reference to FIG. 3 (or various subsets thereof). Some embodiments may then determine a consensus promotion result, as indicated by block 222. In some embodiments, consensus may be determined with the techniques described above by which results output by un-trusted computing nodes operated by malicious actors are disregarded in favor of consensus results.

Some embodiments may then publish the resulting promotion trust assertion to a tamper-evident, immutable, decentralized data store, as indicated by block 224. Additionally or alternatively, some embodiments may output the result of the determination to the participating entity computing device or other participating entity computing devices corresponding to the other components of the computing environment 70 described above. For example, various software development tooling used in the next stage may receive the output and that output may cause that software development tooling to transform the software asset in accordance with the next stage upon being promoted (or block the transformation in the alternative). In some embodiments, a current stage of a software asset may be recorded as a trust assertion in the above-described trust records. In some embodiments, the sequence of stages and stages responsive to failure criteria may be specified in the promotion policy, and embodiments may interrogate these records to determine the identifier of the next stage or an identifier of a demotion stage corresponding to a given failed trust record. Upon a plurality of trust criteria being failed, embodiments may determine an earliest stage corresponding to the field criteria and designate the software asset as residing at that early stage in a newly published trust assertion.

In some embodiments, the participating entity computing device 204 may receive a result of the promotion determination, as indicated by block 226. In some embodiments, receiving a result (here and with respect to the other smart contracts herein) is achieved by receiving a response (including pulling a record or receiving a pushed message) indicating that the promotion smart contract executed to completion without error. In some embodiments, receiving the result is achieved by receiving a value indicating whether the software asset is to be promoted to a next stage. In some embodiments, receiving the result includes receiving a value indicating that the software asset is being demoted to a previous stage of the software development workflow at which failed promotion criteria are to be addressed. In some embodiments, receiving the results may include receiving a value sent by the decentralized computing platform, or in some cases receiving the result may include accessing a record in the tamper-evident, immutable, decentralized data store described above designated to store the result. Thus, results may be pushed or pulled. Further, some embodiments may execute a publish-subscribe model in which various participating entity computing devices subscribe to output of various smart contracts pertaining to a channel corresponding to the software asset, or various entities may register callback functions to be executed in specified events based on the result.

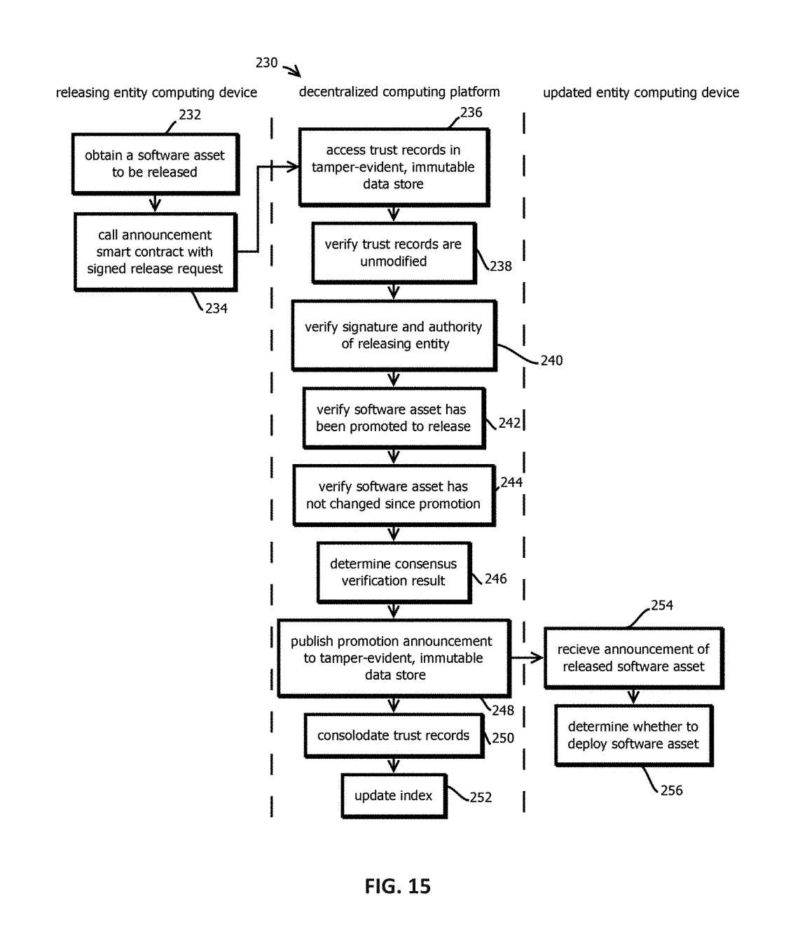

FIG. 15 is a flowchart depicting an example of a process 230 by which the release of a software asset to production may be announced in some embodiments. Again, in this example, different entities including a releasing entity computing device, the decentralized computing platform, and an updated entity computing device may participate in the process 230, though as with the example above, the illustrated functionality may be differently allocated among these computing devices in any permutation, which is not to suggest that any other description herein is limiting.

Some embodiments engage smart contracts to announce release of a new version of code for use in production. Some embodiments engage a smart contract to announce the release and related events, like end of life, to users of the previous version, and the communications may be cryptographically signed and stored in a blockchain (or hash digest thereof stored in the blockchain). Some embodiments may also create summary trust records at release that summarizes or at least aggregate distributed (across the blockchain) trust assertions generated during development and staging to reduce the number of queries to the blockchain and consolidate verification of the software asset as compliant with various release policies.

Some embodiments may include obtaining a software asset to be released, as indicated by block 232. In some embodiments, this may be achieved by receiving an identifier of a software asset to be released without necessarily accessing all code of the software asset, or the entire body of code may be accessed. In some embodiments, the releasing entity computing device that obtains the software asset to be released may be a developer's computing device in which the developer has explicitly submitted a command requesting the functionality of an announcement smart contract be engaged to release a software asset identified by the command. Or in some embodiments, operation 232 may be executed by release infrastructure tooling, such as by an application configured to upload the software asset to a repository accessible to production environments, upload the software asset to an native application store or other walled garden hosted by a provider of mobile operating systems, release the software asset to an enterprise computing environment, begin adding the software assets to production virtual machine images or container images, instantiate the software asset as a lambda function in production serverless computing environments, distribute a monolithic executable application including the software asset, and the like. In some embodiments, the release tooling may automatically engage the announcement smart contract in the course of executing a command requesting release of the software asset.

Some embodiments may call the announcement smart contract with a cryptographically signed release request, as indicated by block 234. In some embodiments, the release of a software asset may be effectuated in association with an identifier of an entity approving the release. In some embodiments, the entity may be a developer, an organization of developers like a software company, a corporate information technology department, a third-party the audit software, an operator of a software repository walled garden, or other entity that is vouching for the released software asset. In some cases, different entities may issue different releases of the same software asset. In some embodiments, the release request may include a cryptographic signature of the releasing entity that has a cryptographic hash digest of the released software asset code, such that the identity of the releasing entity and the absence of tampering of the with the released software asset subsequent to signing can be determined by recalculating hash values and comparing them to verify that they match.

Some embodiments of the decentralized computing platform may receive the call, in some cases with arguments including the signed release request, an identifier of the software asset to be released, an identifier of the entity vouching for the software asset in the release, and in some cases a target environment in (or use case for) which the software asset is to be released, like a walled garden software repository, enterprise computing network, set of package managers, a distributed computing application with a microservices architecture in which the software asset implements one of the services, and the like.

Some embodiments may access the trust records of the software asset in a tamper-evident, immutable, decentralized data store, such as those described above, as indicated by block 236. In some embodiments, accessing the trust records may be achieved by retrieving trust records stored outside of the immutable data store and accessing cryptographic hash digest of those trust records stored as node content in the data store.

Some embodiments may verify that the trust records are unmodified, as indicated by block 238, for instance in accordance with the techniques described above by which the absence of mutation of records in a data store is verified.

Some embodiments may then verify the cryptographic signature and authority of the releasing entity to release the software asset (for various specified purposes in some cases), as indicated by block 240. Some embodiments may access a trust policy to identify whether the entity that signed (i.e., cryptographically signed) the release request has authority to authorize release for a target environment. Some embodiments may verify that the entity purporting to sign the release request has in fact signed the release request by verifying the cryptographic signature with a public key associated with the identified releasing entity in the manner described above.

Some embodiments may verify that the software asset has been promoted to release, as indicated by block 242, for instance, by querying a trust assertion written to the tamper-evident, immutable, decentralized data store in the process described above with reference to FIG. 3.

Some embodiments may then verify that the software asset has not changed since promotion, as indicated by block 242, for instance by recalculating a cryptographic hash digest of the code of the software asset and comparing that cryptographic hash digest to a cryptographic hash digest in the trust assertion documenting the promotion to release (with matches indicating the absence of tampering). Some embodiments may perform a similar verification operation relative to the software asset obtained in block 232.

Some embodiments may determine a consensus verification result, as indicated by block 246, for instance, in accordance with the techniques described above by which verifiable computing techniques are implemented in the decentralized computing platform 80 of FIG. 3. In some embodiments, upon determining that any of the above-described verification operations fails to verify the proposition for which verification is sought, some embodiments may determine as part of the output to block the release, to write a trust record qualifying the release as having failed in some regard, to cause an alarm to be emitted, to cause an email to be sent, or the like. Or upon each of the verify propositions being successfully verified, some embodiments may communicate the release of the software asset with similar techniques.

To this end, some embodiments may publish a promotion announcement in a trust record to the tamper-evident, immutable, decentralized data store, as indicated by block 248. Further, some embodiments may communicate the information via the other above-described channels, including emails, logged alerts, outputting to subscribers in a publication-subscribe architecture, via registered call backs, and the like.

In some embodiments, an updated entity computing device, which is updated in the sense that it obtains new information about the software asset, may receive the announcement of the released software asset, as indicated by block 254. In some embodiments, this information may be pushed or pulled (e.g., from a blockchain). In some embodiments, a plurality of entity computing devices executing, for example, a previous version of the software asset may automatically register to receive updates with configuration management or orchestration tooling that detects the presence of a software asset and registers a callback function or subscribes to obtain updates regarding the software asset.

In this and other examples in which smart contracts communicate results, some computing devices receiving those results may register a callback function with the smart contract or other computing device executing the described functionality. In some embodiments, the computing device may then execute respective callback functions for different computing devices that have registered those callback functions, and in some cases, those callback functions may cause the output to be communicated, for instance, in different forms suitable for the different receiving computing devices in accordance with instructions in the callback functions. Examples include callback function that filters messages according to various criteria, formats messages into a schema of the recipient, and makes an API call with the formatted message to configuration management or orchestration tooling.

In some embodiments, the updated entity computing device may then determine whether to deploy the software asset, as indicated by block 256. Some embodiments may further log a record of the update, cause an alarm to be emitted, cause an email to be sent, cause a text message to be sent, add an issue to an issue tracker repository directing an engineer to coordinate the updated at some point in the future, or otherwise communicate information about the update. Some embodiments may automatically deploy the software asset upon receiving the announcement, for instance, by hot-swapping in a software update. For instance, some embodiments may spin down virtual machines or containers executing a first subset of instances of a service, reform images of the virtual machines or containers for the first subset, and then spinning back up those virtual machines or containers. Some embodiments may then perform a similar operation on a separate subset or provision new instances while an existing set of instances are executing to avoid interrupting a production environment, in some cases redirecting workload with a load balancer to a subset of instances not undergoing updates.

Some embodiments, at software release or other stages, may consolidate trust records, as indicated by block 250. To this end, some embodiments may execute the above-describe consolidation operations to create a new trust record that, for example, summarizes earlier trust records, summarizes the result of applying various policies to the earlier trust records, or the like, in a new trust record that in some cases, may reduce the amount of queries to the decentralized tamper evident, immutable, decentralized data store, as a single consolidated trust record may convey the information needed in what would otherwise include a plurality of queries.

Some embodiments may further update the above-described index (in this and other instances in which records are published to a blockchain), as indicated by block 252, for example, to reference the consolidated trust record or to reference the trust assertion therein documenting the software release. In some embodiments, output of this and other smart contracts may be cryptographically signed by a key of the smart contracts, and alternatively or additionally, the output may include the cryptographic signature of the entity calling the smart contract or the cryptographically signed records upon which an output is based.

FIG. 16 depicts a flowchart of a process 260 by which audit compliance of software assets may be managed in some embodiments. The same qualifications as described above regarding allocation of functionality between the participating entity computing device and the decentralized computing platform apply to this and the other flowcharts herein.

Some embodiments may encode steps (such as conditional logic) of an audit compliance process for software in a smart contract. In some cases, this may include implementing logic of a security compliance process, e.g., penetration testing, security checks by auditors, Safety Act compliance, FIPS compliance, etc. In some cases, cryptographic signatures of stakeholders may be applied to verified versions of the code at issue by the smart contract, and release of the software for certain use-cases may be conditioned by the smart contract on various criteria related to these signatures (or other automated testing criteria implemented in the smart contract itself or automated testing software verified with the techniques described herein). Other forms of compliance that may be managed include compliance with COPPA, HIPPA, GDPR, FIPS, and similar regulations, or compliance with various open-source licensing provisions (e.g., verifying attribution is present, code is made available, etc.) Regulations need not be limited to government regulations and can include standard compliance, ecosystem constraints (like in a native application store), and policies of corporate IT departments. State may be accessed in a blockchain, or in other data stores.

In some embodiments, various entities conducting audits may publish trust records describing those audits to the above-described tamper-evident, immutable, decentralized data store, for instance in association with, like in trust-record graphs of, software assets subject to the audit. In some embodiments, these trust records may be cryptographically signed by the auditing entity or proxy thereof.

Various types of audits may be performed and documented in trust records. Examples include security audits, software license audits, audits regarding software development practices, audits for compliance with various policies of an organization, audits regarding compliance with standards set by standard-setting bodies, audits regarding compliance with various regulations, and audits regarding compliance with various laws. For instance, an audit may indicate whether a software asset complies with license requirements of an open source license, violates an allocation of seats in a commercial software license, or exceeds a number of process threads, transactions, or processors afforded by a commercial software license. In another example, an audit may indicate whether a software asset is using security best practices, for instance, whether the software asset stores passwords in plain text form, whether the software asset filters for reserved terms in a query language from user inputs to impede SQL injection attacks, whether the software asset is configuring a server in a manner regarded as unsecure, whether the software asset is employing a depreciated form of transport layer security encryption, whether the software asset is using a cryptographic hash function known to be vulnerable to brute force attacks, and the like. In some embodiments, the audits may pertain to compliance with various financial regulations, HIPAA, GDPR, Safety Act, FIPS, and the like.

Some embodiments may be configured to determine whether an audit of a previous version of a software asset applies to a new version. For instance, some embodiments may interrogate trust records describing a difference between versions or a cryptographically signed certification stating that the change between versions does not give rise to a new audit requirement. Upon detecting such a record, some embodiments may traverse backwards through a version graph (in some cases, across multiple versions with such certifications), until a version with an audit is detected, and trust records from that audit, in the corresponding trust-record graph of the earlier version of the software asset, may be accessed and compared to the audit criteria.

In some embodiments, audits may be documented in trust records in both machine-readable and human readable formats, for instance in JSON or XML documents and in unstructured natural language text, for instance, in audit reports, both of which may be published to the tamper-evident, immutable, decentralized data store described above. In some embodiments, trust records produced by audits may be cryptographically signed by the auditing entity or proxy thereof, in some cases along with a timestamp of the audit and cryptographic hash digest of the software asset upon which the audit was performed. Further, some embodiments may include a cryptographic hash digest of an audit specification that is part of the audit trust record and is cryptographically signed in some cases additionally by entity promulgating the audit requirements. Where audits are performed programmatically, an auditing application may sign the record, and in some cases, a cryptographic hash digest of code of the auditing application may be part of the cryptographically signed trust record to facilitate verification of the code of the audit application.

In some embodiments, the participating entity computing device may obtain a software asset subject to an audit requirement, as indicated by block 262. In some cases, this may be achieved by obtaining an identifier of the software asset without necessarily holding program code of the software asset in memory of the participating entity computing device.

Next, some embodies may call an audit smart contract with a request to indicate whether the audit requirement is satisfied by trust records reflecting audits, as indicated by block 264. In some embodiments, the call to the audit smart contract may be a call with various arguments that cause the smart contract to obtain an identifier of the software asset, an identifier of the entity requesting the audit, and parameters of the request by which an audit policy specific to the entity and in some cases specific to a type of use case or computing environment may be selected.

In some embodiments, the audit smart contract may receive the call and obtain an audit policy, as indicated by block 266. In some embodiments, the policy may be selected from a plurality of audit policies corresponding to different entities, and in some cases corresponding to different use cases or computing environments for a given entity. For example, user facing software assets may be subject to a different audit policy than is applied to software assets used in development tools. In another example, software assets deployed in a computing environment with access to personally identifiable information, health records, biometric data, financial records, or other sensitive data, may be subjected to a different audit policy, or in some cases audit policies may be encoded in a domain specific programming language in the manner described above, by which different branches may be determined to apply depending on the use case.

Some embodiments may verify that the audit policy is unmodified, for instance with the above-described cryptographic verification techniques. In some embodiments, the audit policy may be stored in the tamper-evident, immutable, decentralized data store or otherwise published to the data store.

Some embodiments and then access audit result trust records in the tamper-evident, immutable, decentralized data store, as indicated by block 268. In some cases, this operation may include recursively traversing a trust-record graph like that described above, accessing an index that associates a cryptographic hash digest of the software asset with a plurality of addresses in a blockchain at which different trust records are published, accessing records stored off chain and cryptographic hash digest thereof stored in node content within a blockchain, or various other techniques.

Some embodiments may verify that the trust records are unmodified, as indicated by block 270, for instance, by verifying that the trust records, when input into a cryptographic hash function produce an output hash value that is consistent with other cryptographic hash outputs within a blockchain.

Some embodiments may verify a cryptographic signature of the audit trust record or audit related trust assertions therein and an authority of an audit entity that cryptographically signed, or upon which a cryptographic signature was provided, as indicated by block 272. In some embodiments, the audit policy may whitelist, blacklist, or otherwise specify authorized audit entities, in some cases indicating a value by which public cryptographic keys of those audit entities may be up obtained to verify the signature and that the audit trust record is not been subject to tampering. Or some embodiments may reference a certificate authority or other entity authorized to vouch for auditing entities.

Some embodiments may verify that the software asset has not changed since the audit, as indicated by block 274. In some embodiments, this may include performing the above-described cryptographic verification techniques by, for example, accessing a cryptographic hash digest of the software asset upon which the audit was performed in an audit trust record and comparing that value to a cryptographic hash digest of the software asset obtained in block 262. Upon determining that the values match, the absence of change may be determined, or upon determining that the cryptographic hash values do not match, block 274 may fail to confirm the absence of change.

Some embodiments may determine consensus verification results, as indicated by block 276. For example, upon any of the verification operations described above in the audit smart contract failing to verify the proposition described, some embodiments may emit alarms like those described above, log results like those described above with reference to other smart contracts, or cause a result to otherwise be qualified. In some embodiments, the determination may be made with the above-described consensus protocols to mitigate the risk of a malicious actor controlling a minority of the un-trusted computing nodes.

Some embodiments may compare audit criteria from the audit policy to audit trust assertions in audit trust records to determine whether the audit criteria are satisfied, as indicated by block 278. Again, the above-described rules engine or a similar rules engine may be applied, or some embodiments may employ the above-describe machine learning approach, for instance, with a model trained upon a labeled training set including software assets for which audit criteria are satisfied and software assets for which audit criteria are not satisfied.

Audit criteria may take any of a variety of forms, including satisfying the above-described examples of audits, the absence of specified types of audit failures, the inclusion of specified types of audit approvals, or combinations thereof, such as positive results from Boolean expressions to which audit results are input, or audit scores exceeding (or otherwise satisfying) some threshold.

Some embodiments may determine a consensus audit result, as indicated by block 280, for instance with the above-described consensus protocols. In some cases, audit results may indicate whether the software asset has satisfied a specified audit, has satisfied each of a set of audit requirements specified in the audit policy, has satisfied various aspects of a given audit, has been audited subject to a required audit, and in some cases when audit results expire or criteria by which a given audit is deemed to not apply to subsequent versions. In some embodiments, a result may be written as a trust record, such as one that consolidates previous trust records, in the trust-record graph of the software asset in the tamper-evident, immutable, decentralized data store described above.

Some embodiments may output the audit results, which may be received by the participating entity computing device, as indicated by block 282. In some embodiments, results may be logged, and in the event of an audit requirement failing to be met, an alarm may be emitted, execution of the software asset may be blocked, inclusion of the software asset in a virtual machine image or container image may be blocked, or the set of computing environments in which the software asset is deployed may be constrained, e.g., the software asset may be excluded from a walled-garden repository of software assets.

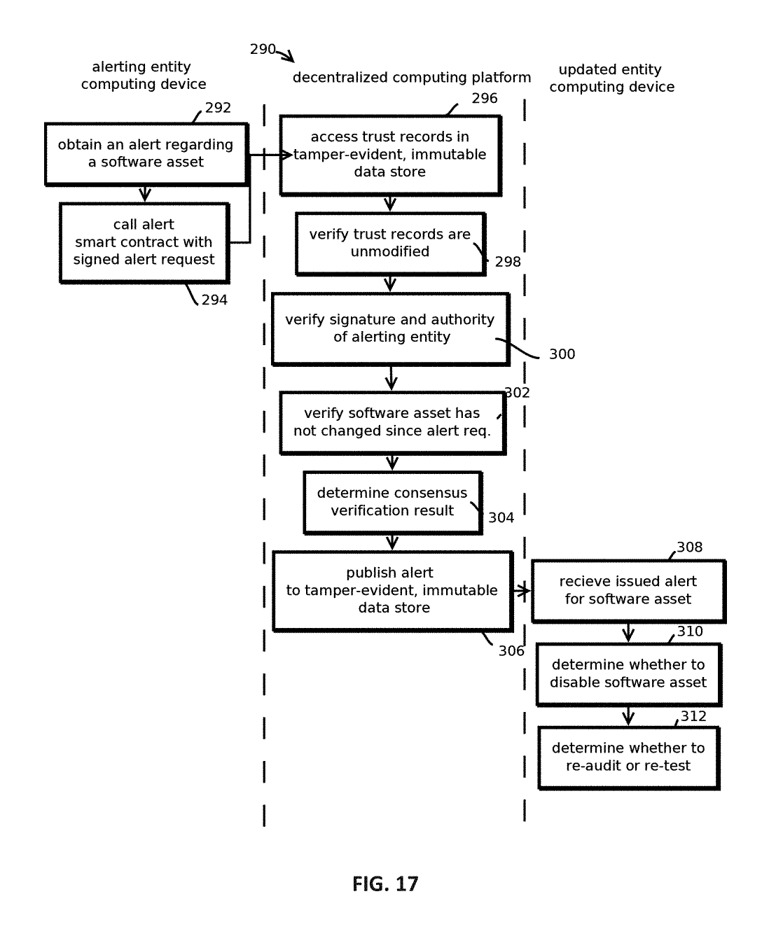

FIG. 17 shows an example of a process 290 by which alerts pertaining to software assets may be promulgated without a central authority verifying the alerts. Some embodiments implement, in a smart contract, logic related to end-of-life, end-of-service, vulnerability announcements, and updates for released code. In some cases, this may include publish/subscribe functionality for stakeholders, in some embodiments, pushing alerts to smart contracts, or publishing records that are polled by stakeholders (e.g., before (and in response to a request for) executing, installing, calling, or accepting output from a software asset). Some embodiments may document, in standardized records, events related to such alerts and verify that entities seeking to write such records are authorized to do so via PKI. Some embodiments may further document such events in verifiable, cryptographically signed records. Some embodiments may further push alerts upward through a call graph for software assets including the asset for which an alert is issued.

In some embodiments, an alerting entity computing device, the decentralized computing platform, and an updated entity computing device (or other devices) may participate in the process 290. In some embodiments, the allocation of functionality may be different from that depicted and may reside in any permutation of allocation of the described functionality among the various entities described, which is not to suggest that any other description herein is limiting.

In some embodiments, the alerting entity may obtain an alert regarding a software asset, as indicated by block 292. Alerts may contain information about the software asset, such as newly obtained information. In some embodiments, the alerts are alerts to inform others of an end-of-life or end-of-service date of the software asset and the information of the alert specifies the type of date and the date. In some embodiments, the alerts describe vulnerabilities of the software asset, for instance, indicating functionality of the software asset exposed to the vulnerability, configurations of the software asset in which the vulnerability is active, computing environments in which the software asset's vulnerability is active, versions of the software asset exposed to the vulnerability, and the severity of the vulnerability (for example, whether the vulnerability leaks information or permits arbitrary attacker-supplied code execution). In some cases, security alerts may specify hardware in which the vulnerability is active. In some embodiments, the information in the alert may instead identify the preceding attributes for cases in which the vulnerability is inactive. In some embodiments, the alert may pertain to (and information in the alert may describe) a software license, a change in documentation of the software asset, a release date for a new version that is planned, a software bug of the software asset, along with attributes of scenarios in which the software bug is active or inactive, like those described above with regard to vulnerabilities, along with a description of functionality indicated by the bug.

In some embodiments, the obtained alert may include a timestamp, an identifier of the software asset, like a cryptographic hash digest thereof, an identifier of an alerting entity, in some cases, including an organization, software application issuing the alert, developer requesting the alert, and the like. In some embodiments, the obtained alert may be cryptographically signed by such an entity or proxy thereof. Cryptographically signing a message may include cryptographically signing the entire message or a salient subset thereof, e.g., a trust record having a cryptographically signed trust record is a cryptographically signed trust record even if the cryptographic signature itself is not input into the hash function of the cryptographic signature and is instead included as metadata or the trust assertions.

Some embodiments may call an alert smart contract executing on the decentralized computing platform with the cryptographically signed alert request, as indicated by block 294.

In some embodiments, this may cause instances of the smart contract to access trust records in the tamper-evident, immutable, decentralized data store in a trust-record graph like that described above, as indicated by block 296.

Some embodiments may proceed to verify that the trust records are unmodified in the manner described above, as indicated by block 298, and some embodiments may verify the cryptographic signature and authority of the alerting entity to issue the alert, as indicated by block 300. In some embodiments, an alert policy may specify a whitelist or blacklist of organizations, developers, or other entities authorized to issue alerts (or certificate authorities authorized to vouch for such entities), in some cases with different policies being applied for a given alert for different receiving entities corresponding to different instances of the updated entity computing device. For instance, one user of the software asset may only wish to receive alerts pertaining to vulnerabilities, while another may wish to receive alerts pertaining to both vulnerabilities and software bugs, while a third may wish to receive all alerts as long as those alerts are authorized by a specified alerting entity. Some embodiments may input the alert request into an instance of the above-described rules engine to apply rules in the various policies to the alert to determine recipient-specific authority of the alerting entity, and in some cases recipient-specific and alert-specific authority.

In some cases, for some types of alerts, such as reports of vulnerabilities or bugs, an entity providing the software asset may host a bug bounty or vulnerability bounty program with the alert smart contract. For instance, some embodiments may receive proposed alerts from the public with the smart contract and then require a second entity, e.g., a developer of the entity operating the program, to review and confirm the alert before the alert is issued. In some cases, the process may verify that an authorized entity has cryptographically signed a verification of the alert upon reviewing such a submission. In some cases, the verifying entity may classify the alert, e.g., according to a severity of the issue, and in some cases, the alert smart contract may determine an amount of cryptographic tokens corresponding to the severity, and cause the amount of cryptographic tokens to be transferred to a blockchain wallet of the alerting entity, e.g., by updating a ledger in the directed acyclic graph of cryptographic hash pointers specifying a current holder of the cryptographic tokens.

Some embodiments may verify that the software asset is not changed since the alert request, as indicated a block 302, for instance with a cryptographic hash digest of the alert request in the manner described above.

Some embodiments may determine a consensus verification result, as indicated by block 304. In some embodiments, upon a failure of any form of verification, the alert may be blocked, in some cases on an updated entity-by-entity basis for recipients or candidate recipients of the alert. Alternatively, upon each of the verification results passing, the alert may be issued. Or in some cases, alerts may be issued with metadata qualifying the alert, indicating aspects in which the above-described verification operations failed to verify the stated proposition. Verification is expected to impede malicious alerts seeking to force targets to revert to an earlier less secure version or spam recipients.

Some embodiments may publish the alert to the tamper-evident, immutable, decentralized data store, as indicated by block 306, which as indicated above may include storing the information of the alert in node content of a blockchain, storing a cryptographic hash digest of the alert in node content and storing the alert off chain, or otherwise causing updated entity computing devices to have access to the alert and a value indicating a result of the verification determination of block 304.

In some embodiments, the updated entity computing device may receive the announcement of the alert for the software asset, as indicated by block 308. In some embodiments, received announcements may be pushed or pulled. In some embodiments, entities operating software assets may subscribe to alerts pertaining to the software assets, and in some cases such entities may register callback functions by which entity-specific specified functionality is executed in the decentralized computing platform 290 responsive to an alert.

In some embodiments, the updated entity computing device may further verify a cryptographic signature of the alert and content of the alert. In some embodiments, the updated entity may determine whether to disable the software asset in response the alert, as indicated by block 310. In some embodiments, the updated entity may access a set of rules that are applied to the alert, and the rules may specify responsive actions including disabling the software asset, reverting to a previous version of the software asset, constraining access of the software asset to computing resources, causing an alarm to be emitted, causing an email to be sent, causing a text message to be sent, or in some cases determining whether to re-audit or retest the software asset, as indicated by block 312.

In some cases, alerts may be propagated through constituency graphs of software assets, e.g., by identifying software assets that invoke functionality of a given software asset subject to an alert. In some cases, entities may execute an alert registration process (e.g., as part of releasing, installing, or executing a software asset). In some embodiments, a smart contract or code executed by a computing device hosting another component of computing environment 70 may recursively traverse the constituency graph of software assets and generate a list of constituent software assets corresponding to visited nodes. In some embodiments, this routine or another may register to receive alerts pertaining to each software asset in the list, e.g., in the manner described below via registered callbacks, emails, various forms of publish/subscribe architectures, and the like. In some cases, constituent software assets may be associated with indexes (updated in the preceding process) that list other software assets that invoke functionality of the constituent software asset. Or in some cases, entities may register to receive updates for each software asset in the constituency graph upon registering for a software asset that serves as an entry point to the graph. The resulting index, or other reverse manifests (e.g., either mapping entities to software assets, or software assets to other software assets in an opposite direction of invocation), may be interrogated during the following process, e.g., by the alert smart contract, to select additional updated entities.

For instance, an entity may register to receive alerts pertaining to software asset A, and software asset B may be invoked by software asset A. Upon receiving an alert pertaining to software asset B, some embodiments may access a reverse manifest of software asset B and detect that software asset A invokes software asset B. Embodiments may then access a list of entities registered to receive alerts pertaining to software asset A, determine whether the entity is already on a list for software asset B, and upon determining that it is not, add the entity to the list of entities to receive updates pertaining to software asset B. In some embodiments, alerts arising from such a relationship may be augmented for upstream registrations by placing the alert in the context of a stack trace by which registration of an upstream software asset resulted in receipt of an alert pertaining to a downstream software asset. In some cases, indexes or other reverse manifests may be formed before or in response to receiving an alert. Some embodiments may recursively traverse a reverse manifest graph (where directional edges are the opposite of those in FIG. 1) to form a list of recipients. Some embodiments may detect duplicate alerts for individual entities and consolidate those alerts, e.g., appending a list of upstream software assets for which an entity has registered to receive alerts to alert information, rather than providing otherwise duplicate messages with the same alert information for every upstream software asset. Thus, a given alert may be presented differently to different recipients, e.g., due to different consolidation or different stack traces. In some cases, an entity may specify criteria by which alerts are filters, and in some cases, different criteria may be applied to these transitive alerts, e.g., based on a threshold number of hops across reverse manifests to reach given software asset from the software asset to which an alert pertains.

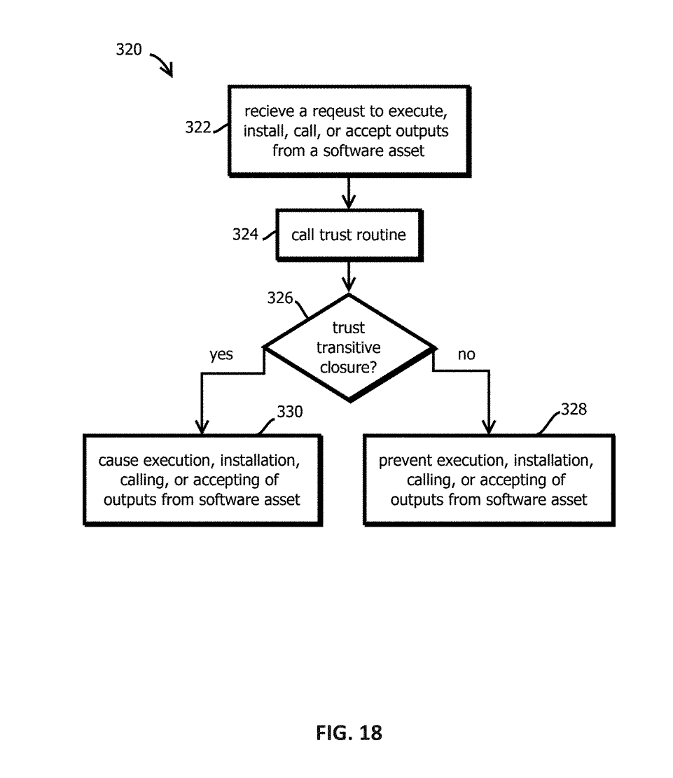

Some embodiments may include a process 320 shown in FIG. 18 by which execution of a software asset is conditioned on whether trust transitive closure can be obtained based on records in the tamper-evident, immutable, decentralized data store described above. In some embodiments, the process 320 may call the process 180 of FIG. 13 to obtain trust transitive closure, or in some cases, any permutation of the other above-described smart contracts.

In some embodiments, the process 320 may be executed by a smart contract or participating entity's computing device. In some embodiments, the process 320 may be executed by both of these computing systems, for instance, with different functionality executed by different portions of the computing systems. Some embodiments condition execution of code on documented proof that various criteria related to code provenance are satisfied, e.g., demonstrating it from a trusted developer (or organization), compiler (or interpreter), and passed tests of a test suite. Some embodiments may recursively interrogate a call graph of the code (including accessed API's) to verify these criteria, in some cases, applying different criteria based on the environment (e.g., jurisdictional or computational) in which the code will execute. In some cases, this may include verifying hardware and firmware by interrogating records encoded therein, like a cryptographic signature hard coded into a chip or written to a register by firmware.

In some embodiments, the process 320 includes receiving a request to execute, install, call, or accept outputs from a software asset, as indicated by 322. In some embodiments, the process 320 may be executed by a driver within an operating system that intercepts calls to executables, requests to allocate memory to a process, or requests to convey a message through a network stack and determines whether the requests are to be permitted. Or in some embodiments, the software asset itself may include code that effectuate the process 320. In some embodiments, the process 320 may be executed when determining whether to include a software asset in a build, include a software asset in a virtual machine image, include the software asset in a container image, install an executable in an operating system, or instantiate an instance of the software asset in an extant virtual machine or container or as a lambda function. In some embodiments, the process 328 may be triggered by a request to an application program interface at which functionality of the software asset is exposed or upon receiving results from the application program interface before determining whether to accept those outputs.

Some embodiments may call a trust routine, like the trust evaluation function described above with reference to FIG. 13, as indicated by block 324. In some embodiments, this call may include the operations of block 186 described above. In some embodiments, a plurality of different smart contracts, like any subset or all of the above-described smart contracts, may be called, and determinations may be based on whether anyone, a specified subset, more than a threshold amount, or various other permutations of the different smart contracts indicate trustworthiness of the software asset according to different respective facets of trust.

Some embodiments may determine whether trust transitive closure is indicated by results output by the trust routine, as indicated by block 326. Or some embodiments may determine whether specified portions of a constituency graph provide adequate indicia of trust in accordance with the techniques described above. For example, some embodiments may whitelist or blacklist different portions of the constituency graph to indicate which portions must be deemed trustworthy.

Upon determining that trust transitive closure, or some threshold approximation thereof, was not obtained, some embodiments may prevent execution, installation, calling, or accepting outputs from the software asset, as indicated by block 328. Some embodiments may further log the failure, emit an alarm, cause an email to be sent, cause a text message to be sent, execute an error handler, present a stack trace like that described above to a user, revert to an earlier version of the software asset, or attempt to execute, install, call, or except outputs from a specified alternative to the software asset.

Alternatively, upon obtaining trust transitive closure, or one of the above-described threshold approximations, some embodiments may cause execution, installation, calling, or accepting outputs from the software asset. For example, some embodiments of a driver may permit access to the executable, or some embodiments of the driver sitting in a network stack may permit an application program interface call or results to progress through a networking stack.

In some embodiments, the result of the determination may be held in cache memory for re-use for some duration of time. In some cases, the determination along with a timestamp may be cryptographically signed with a private cryptographic key of the entity making the determination, and until a threshold amount of time or a threshold number of calls have occurred, the cached version may be referenced. Some embodiments may periodically re-obtain trust transitive closure, e.g., daily, without waiting for a currently executing software asset to be re-installed or restarted, and some embodiments may terminate currently executing software assets in response to failure to obtain trust transitive closure.

FIG. 19 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A method of releasing software assets with programs that afford verifiable, decentralized documentation of indicia of trustworthiness of the software assets, the method comprising: obtaining, with one or more processors, a software asset to be released by a releasing entity from a staging environment to a production environment; calling, with one or more processors, a program with replicated instances executed on a decentralized computing platform configured to persist state to a tamper-evident, immutable, decentralized data store, the call requesting the program to release the software asset to the production environment, wherein: respective instances of the program are configured to publish release documentation by which provenance of the software asset is verifiable to the tamper-evident, immutable, decentralized data store, respective instances of the program are configured to verify a cryptographic signature associated with the software asset, the cryptographic signature establishes that the software asset being released has not been tampered with subsequent to signing, the cryptographic signature establishes that the releasing entity or a proxy of the releasing entity has access to a cryptographic key by which the cryptographic signature was formed, and the decentralized computing platform is configured to reach a consensus verification determination among verification results from the replicated instances of the program; and receiving, with one or more processors, a response from the decentralized computing platform indicating that the software asset has been released to the production environment.
2. The method of embodiment 1, wherein: the program includes an announcement smart contract; the tamper-evident, immutable, decentralized data store includes a blockchain; the software asset is a new version that supersedes a previous version; the announcement smart contract is configured to: cause an entity using the previous version of the software asset to be notified that the releasing entity is releasing the new version; and indicate that the new version is cryptographically signed by a valid cryptographic signature of the releasing entity or a certificate authority serving as a proxy of the releasing entity.
3. The method of embodiment 2, wherein: causing an entity using the previous version of the software asset to be notified that the releasing entity is releasing the new version comprises: accessing a plurality of callbacks programs registered with the announcement smart contract, one of the callback programs being registered by the entity using the previous version; and causing the plurality of callback programs to be executed responsive to the call to the program, wherein the one of the callback programs causes a message indicating that the releasing entity is releasing the new version to be sent to the entity using the previous version.
4. The method of embodiment 2, wherein: the notification is configured to cause an operating system in which the previous version is installed to present a warning that the previous version is superseded.
5. The method of embodiment 2, wherein: the notification comprises a hash digest based on the software asset by which the entity using the previous version verifies that released software asset corresponds to the notification by re-computing the hash digest on a version of the software asset downloaded in response to the notification.
6. The method of embodiment 2, wherein: the announcement smart contract is configured to cause an email with the notification to be sent to an email address associated with the entity using the previous version.
7. The method of embodiment 2, wherein: the announcement smart contract is configured to cause a plurality of messages to be sent to a plurality of addresses in an address space of the decentralized computing platform, the plurality of addresses being addresses of entities that subscribed to announcements pertaining to a software identifier that is consistent across different versions of the software asset.
8. The method of embodiment 2, wherein: calling the announcement smart contract with a call including arguments comprising: an indication of an end-of-life date or end-of-support date of the previous version of the software asset; a request to announce the end-of-life date or end-of-support date of the previous version of the software asset; and another cryptographic signature by which absence of modifications to the indication is verifiable and that is cryptographically signed by the releasing entity; the announcement smart contract is configured to verify the other cryptographic signature and cause the entity using the previous version to be notified of the end-of-life date or end-of-support date; and an execution smart contract executed on the decentralized computing platform is configured to block execution of the previous version of the software asset in response to a record of the new version or the end-of-life date or end-of-support date stored in the blockchain.
9. The method of any one of embodiments 1-8, wherein: obtaining the software asset to be released comprises receiving a request from a computing device of a developer of the software asset; and the cryptographic signature includes a ciphertext based on a time stamp of the request and a hash digest of the software asset, the ciphertext being a value encrypted with a private cryptographic key of the developer, the private cryptographic key being a lattice-based cryptographic key.
10. The method of any one of embodiments 1-9, wherein: obtaining the software asset to be released comprises obtaining a request formed by release infrastructure responsive to the release infrastructure being engaged to release the software asset; the program is configured to verify both a cryptographic signature of a developer that engaged the release infrastructure and a cryptographic signature of the release infrastructure; and the release infrastructure is configured to make the software asset available to users of the software asset and includes one or more of the following: a code repository accessible by a package manager; a native application repository hosted by a provider of a mobile computing device operating system; an application that packages the software asset with other software assets into an installer package; or a network-accessible code repository accessed by an orchestration service.
11. The method of any one of embodiments 1-10, wherein: the cryptographic signature is that of a certificate authority signing on behalf of the releasing entity after verifying the releasing entity's identity.
12. The method of any one of embodiments 1-11, wherein: the program includes a promotion smart contract configured to release the software asset upon determining that software quality criteria are satisfied based on cryptographically signed trust assertions stored in the tamper-evident, immutable, decentralized data store during pre-release stages of a software development workflow; and the software asset to be released is obtained responsive to the promotion smart contract determining to release the software asset.
13. The method of embodiment 12, wherein: the promotion smart contract is configured to publish a release trust record to the tamper-evident, immutable, decentralized data store, the release trust record including at least three of the following: a release version identifier of the software asset; identifiers of a set of target or supported platforms upon which the software asset is configured to execute; a set of certifications for which the released software asset is compliant with and identifiers of respective certification criteria of the certifications; or natural language text documentation of the software asset.
14. The method of embodiment 12, wherein the promotion smart contract is configured to: traverse a graph of a plurality of trust records stored at a plurality of different addresses in the tamper-evident, immutable, decentralized data store, the plurality of trust records documenting trust assertions published to the tamper-evident, immutable, decentralized data store at different stages of development and staging of the software asset; summarize trust assertions from the plurality of trust records in a summary trust record; and publish the summary trust record to an address of the tamper-evident, immutable, decentralized data store, wherein the summary trust record is accessible with fewer queries to the tamper-evident, immutable, decentralized data store than the plurality of trust records.
15. The method of embodiment 14, wherein: summarizing the trust assertions comprises applying criteria of a plurality of policies to the trust assertions to determine which of the plurality of policies are satisfied by the trust assertions; and the summary trust record includes a plurality of results of applying the policies associated with respective identifiers of the policies and respective hash digests of the policies.
16. A tangible, non-transitory, machine-readable medium storing instructions that when executed by a data processing apparatus cause the data processing apparatus to perform operations comprising: the operations of any one of embodiments 1-15.
17. A system, comprising: one or more processors; and memory storing instructions that when executed by the processors cause the processors to effectuate operations comprising: the operations of any one of embodiments 1-15.

What is claimed is:

1. A method of releasing software assets with programs that afford verifiable, decentralized documentation of indicia of trustworthiness of the software assets, the method comprising:
obtaining, with one or more processors, a software asset to be released by a releasing entity from a staging environment to a production environment;
calling, with one or more processors, a program with replicated instances executed on a decentralized computing platform configured to persist state to a tamper-evident, immutable, decentralized data store, the call requesting the program to release the software asset to the production environment, wherein:
respective instances of the program are configured to publish release documentation by which provenance of the software asset is verifiable to the tamper-evident, immutable, decentralized data store,
respective instances of the program are configured to verify a cryptographic signature associated with the software asset,
the cryptographic signature establishes that the software asset being released has not been tampered with subsequent to signing,
the cryptographic signature establishes that the releasing entity or a proxy of the releasing entity has access to a cryptographic key by which the cryptographic signature was formed, and
the decentralized computing platform is configured to reach a consensus verification determination among verification results from the replicated instances of the program; and
receiving, with one or more processors, a response from the decentralized computing platform indicating that the software asset has been released to the production environment.

2. The method of claim 1, wherein:
the program includes an announcement smart contract;
the tamper-evident, immutable, decentralized data store includes a blockchain;
the software asset is a new version that supersedes a previous version;
the announcement smart contract is configured to:
cause an entity using the previous version of the software asset to be notified that the releasing entity is releasing the new version; and
indicate that the new version is cryptographically signed by a valid cryptographic signature of the releasing entity or a certificate authority serving as a proxy of the releasing entity.

3. The method of claim 2, wherein:
causing an entity using the previous version of the software asset to be notified that the releasing entity is releasing the new version comprises:
accessing a plurality of callbacks programs registered with the announcement smart contract, one of the callback programs being registered by the entity using the previous version; and
causing the plurality of callback programs to be executed responsive to the call to the program, wherein the one of the callback programs causes a message indicating that the releasing entity is releasing the new version to be sent to the entity using the previous version.

4. The method of claim 2, wherein:
the notification is configured to cause an operating system in which the previous version is installed to present a warning that the previous version is superseded.

5. The method of claim 2, wherein:
the notification comprises a hash digest based on the software asset by which the entity using the previous version verifies that released software asset corresponds to the notification by re-computing the hash digest on a version of the software asset downloaded in response to the notification.

6. The method of claim 2, wherein:
the announcement smart contract is configured to cause an email with the notification to be sent to an email address associated with the entity using the previous version.

7. The method of claim 2, wherein:
the announcement smart contract is configured to cause a plurality of messages to be sent to a plurality of addresses in an address space of the decentralized computing platform, the plurality of addresses being addresses of entities that subscribed to announcements pertaining to a software identifier that is consistent across different versions of the software asset.

8. The method of claim 2, wherein:
calling the announcement smart contract with a call including arguments comprising:
an indication of an end-of-life date or end-of-support date of the previous version of the software asset;
a request to announce the end-of-life date or end-of-support date of the previous version of the software asset; and
another cryptographic signature by which absence of modifications to the indication is verifiable and that is cryptographically signed by the releasing entity;
the announcement smart contract is configured to verify the other cryptographic signature and cause the entity using the previous version to be notified of the end-of-life date or end-of-support date; and
an execution smart contract executed on the decentralized computing platform is configured to block execution of the previous version of the software asset in response to a record of the new version or the end-of-life date or end-of-support date stored in the blockchain.

9. The method of claim 1, wherein:
obtaining the software asset to be released comprises receiving a request from a computing device of a developer of the software asset; and
the cryptographic signature includes a ciphertext based on a time stamp of the request and a hash digest of the software asset, the ciphertext being a value encrypted with a private cryptographic key of the developer, the private cryptographic key being a lattice-based cryptographic key.

10. The method of claim 1, wherein:
obtaining the software asset to be released comprises obtaining a request formed by release infrastructure responsive to the release infrastructure being engaged to release the software asset;
the program is configured to verify both a cryptographic signature of a developer that engaged the release infrastructure and a cryptographic signature of the release infrastructure; and
the release infrastructure is configured to make the software asset available to users of the software asset and includes one or more of the following:
a code repository accessible by a package manager;
a native application repository hosted by a provider of a mobile computing device operating system;
an application that packages the software asset with other software assets into an installer package; or
a network-accessible code repository accessed by an orchestration service.

11. The method of claim 1, wherein:
the cryptographic signature is that of a certificate authority signing on behalf of the releasing entity after verifying the releasing entity's identity.

12. The method of claim 1, wherein:
the program includes a promotion smart contract configured to release the software asset upon determining that software quality criteria are satisfied based on cryptographically signed trust assertions stored in the tamper-evident, immutable, decentralized data store during pre-release stages of a software development workflow; and
the software asset to be released is obtained responsive to the promotion smart contract determining to release the software asset.

13. The method of claim 12, wherein:
the promotion smart contract is configured to publish a release trust record to the tamper-evident, immutable, decentralized data store, the release trust record including at least three of the following:
a release version identifier of the software asset;
identifiers of a set of target or supported platforms upon which the software asset is configured to execute;
a set of certifications for which the released software asset is compliant with and identifiers of respective certification criteria of the certifications; or
natural language text documentation of the software asset.

14. The method of claim 12, wherein the promotion smart contract is configured to:
traverse a graph of a plurality of trust records stored at a plurality of different addresses in the tamper-evident, immutable, decentralized data store, the plurality of trust records documenting trust assertions published to the tamper-evident, immutable, decentralized data store at different stages of development and staging of the software asset;
summarize trust assertions from the plurality of trust records in a summary trust record; and
publish the summary trust record to an address of the tamper-evident, immutable, decentralized data store, wherein the summary trust record is accessible with fewer queries to the tamper-evident, immutable, decentralized data store than the plurality of trust records.

15. The method of claim 14, wherein:
summarizing the trust assertions comprises applying criteria of a plurality of policies to the trust assertions to determine which of the plurality of policies are satisfied by the trust assertions; and
the summary trust record includes a plurality of results of applying the policies associated with respective identifiers of the policies and respective hash digests of the policies.

16. The method of claim 1, wherein:
the program is configured to execute steps for issuing a verified announcement pertaining to a software asset with a smart contract.

17. A tangible, non-transitory, machine-readable medium storing instructions that when executed by one or more processors effectuate operations comprising:
obtaining, with one or more processors, a software asset to be released by a releasing entity from a staging environment to a production environment;
calling, with one or more processors, a program with replicated instances executed on a decentralized computing platform configured to persist state to a tamper-evident, immutable, decentralized data store, the call requesting the program to release the software asset to the production environment, wherein:
respective instances of the program are configured to publish release documentation by which provenance of the software asset is verifiable to the tamper-evident, immutable, decentralized data store,
respective instances of the program are configured to verify a cryptographic signature associated with the software asset,
the cryptographic signature establishes that the software asset being released has not been tampered with subsequent to signing,
the cryptographic signature establishes that the releasing entity or a proxy of the releasing entity has access to a cryptographic key by which the cryptographic signature was formed, and
the decentralized computing platform is configured to reach a consensus verification determination among verification results from the replicated instances of the program; and
receiving, with one or more processors, a response from the decentralized computing platform indicating that the software asset has been released to the production environment.

18. The medium of claim 17, wherein:
the program includes an announcement smart contract;
the tamper-evident, immutable, decentralized data store includes a blockchain;
the software asset is a new version that supersedes a previous version;
the announcement smart contract is configured to:
cause an entity using the previous version of the software asset to be notified that the releasing entity is releasing the new version; and
indicate that the new version is cryptographically signed by a valid cryptographic signature of the releasing entity or a certificate authority serving as a proxy of the releasing entity.

19. The medium of claim 18, wherein:
causing an entity using the previous version of the software asset to be notified that the releasing entity is releasing the new version comprises:
accessing a plurality of callbacks programs registered with the announcement smart contract, one of the callback programs being registered by the entity using the previous version; and
causing the plurality of callback programs to be executed responsive to the call to the program, wherein the one of the callback programs causes a message indicating that the releasing entity is releasing the new version to be sent to the entity using the previous version.

20. The medium of claim 17, wherein:
the program includes a promotion smart contract configured to release the software asset upon determining that software quality criteria are satisfied based on cryptographically signed trust assertions stored in the tamper-evident, immutable, decentralized data store during pre-release stages of a software development workflow; and
the software asset to be released is obtained responsive to the promotion smart contract determining to release the software asset.
